(19) United States
(12) Patent Application Publication
(10) Pub. No.: US 2025/0272111 A1
(43) Pub. Date: Aug. 28, 2025

(54) SYSTEM DESIGN LEARNING APPARATUS, SYSTEM DESIGN LEARNING METHOD, AND COMPUTER-READABLE RECORDING MEDIUM

(71) Applicant: NEC Corporation, Minato-ku, Tokyo (JP)

(72) Inventor: Yutaka YAKUWA, Tokyo (JP)

(73) Assignee: NEC Corporation, Minato-ku, Tokyo (JP)

(21) Appl. No.: 18/857,900

(22) PCT Filed: May 13, 2022
(86) PCT No.: PCT/JP2022/020267

§ 371 Date: Oct. 18, 2024

(51) Int. Cl. G06F 9/445

(52) U.S. Cl. CPC G06F 9/44505

(57) ABSTRACT

A system design learning apparatus includes: a functional requirement learning unit that, by executing a concretization processing, learns with regard to a first learning model that outputs an evaluation value representing a potentiality of the system requirement or proposed system configuration meeting a functional requirement of the system and, furthermore, being converted into a concrete system configuration, which is information representing the configuration of the system not including the abstract portions; a performance measurement unit that, executes a performance measurement processing on the performance of the concrete system configuration to measure performance data; and a non-functional requirement learning unit that, learns with regard to a second learning model that outputs an evaluation value representing a potentiality of the concrete system configuration being able to exhibit performance meeting a nonfunctional requirement, by using the performance data.

### TECHNICAL FIELD

The present disclosure relates to a system design learning apparatus and a system design learning method for use in system design, and to a computer-readable recording medium including a program for realizing the apparatus and method recorded thereon.

### BACKGROUND ART

When designing an ICT (Information and Communication Technology) system, first, in the requirements definition, the designer creates information (system requirements) representing the configuration of the ICT system, including concrete and abstract elements, that consolidates the customer's requirements and requests.

The configuration of an ICT system can be represented by graphs, based on concepts such as IBN (Intent-Based Networking). The graphs use nodes and edges to represent elements (components) included in the configuration of the ICT system. Nodes are components representing devices, applications, and the like, for example. Edges are components representing the connection relation between two nodes.

Next, in automated design, abstract portions included in the system requirements are concretized, based on concretization rules created in advance, and information (concrete system configuration) representing the configuration of the ICT system in a deployable state is derived.

A concretization rule is information used in order to convert an abstract portion into a concrete portion by concretizing the abstract portion in a stepwise manner.

Concrete portions are components or configurations that have been confirmed for actual use in the ICT system. Abstract portions are unconfirmed components or configurations whose function has been confirmed but whose actual use in the system has not been concretely confirmed.

As related art, Patent Document 1 discloses a system configuration derivation device that concretizes abstract elements in a stepwise manner and derives a concrete system configuration of a deployable ICT system. According to the system configuration derivation device of Patent Document 1, unconfirmed elements included in the system requirements are concretized in a stepwise manner using the concretization rules, and a concrete system configuration that can be implemented is ultimately derived.

Specifically, the system configuration derivation device of Patent Document 1 detects one or more abstract portions included in the system requirements using the concretization rules and converts the detected abstract portions into concrete portions to generate a proposed system configuration or a concrete system configuration.

A proposed system configuration is information indicating a configuration including abstract portions, prior to a concrete system configuration being derived. Accordingly, the system requirements can also be viewed as proposed system configurations.

A proposed system configuration that includes abstract portions is converted again using the concretization rules. Thereafter, a concrete system configuration is derived when conversion is repeated and all portions are concretized.

However, when concretizing a system requirement and a proposed system configuration, a plurality of concretization rules are applied. As such, the proposed system configuration or concrete system configuration that is derived changes according to the selected concretization rules and the order in which the concretization rules are selected. That is, depending on the order in which the concretization rules are selected, different configurations of the proposed system configuration and concrete system configuration are derived.

Also, when a large number of concretization rules are applied, the numbers of proposed system configurations and concrete system configurations that are generated become huge. Furthermore, the plurality of different concrete system configurations may also include concrete system configurations that do not meet the system requirements. Accordingly, it is envisaged that efficient derivation of a concrete system configuration is not possible with the system configuration derivation device of Patent Document 1.

In view of this, in order to efficiently derive a concrete system configuration, it is important to appropriately determine the selection of concretization rules and the advantages and disadvantages of the order in which the concretization rules are selected.

As related art, Non-Patent Document 1 discloses a technology for appropriately determining the selection of concretization rules and the advantages and disadvantages of the order in which the concretization rules are selected.

### LIST OF RELATED ART DOCUMENTS

### Patent Document

Patent Document 1: International Publication No. WO 2019/216082

### Non-Patent Document

Non-Patent Document 1: Takashi Maruyama et al.: “Accelerated Search for Search-Based Network Design Generation Scheme with Reinforcement Learning”, IEICE Technical Report, Vol. 118, No. 483, ICM2018-71, pp. 123-128, March 2019.

### SUMMARY OF INVENTION

### Problems to be Solved by the Invention

However, the reinforcement learning disclosed in Non-Patent Document 1 relates to functional requirements and does not relate to nonfunctional requirements.

The above-described requirements definition is generally divided broadly into two types: functional requirements and nonfunctional requirements. Functional requirements are requirements that prescribe functions that an ICT system should have. Nonfunctional requirements are requirements that prescribe elements other than the functions that an ICT system should have, such as availability, performance, extensibility, operability/maintainability, and security.

An example object of the present disclosure is to provide a system design learning apparatus, a system design learning method, and a computer-readable recording medium for comprehensively learning functional requirements and nonfunctional requirements.

### Means for Solving the Problems

In order to achieve the example object described above, a system design learning apparatus according to an example aspect of the present disclosure includes:
a functional requirement learning unit that, by executing concretization processing for converting abstract portions into concrete portions on a system requirement or proposed system configuration targeted for concretization, which is information representing a configuration of a system including the abstract portions, learns with regard to a first learning model that outputs an evaluation value representing a potentiality of the system requirement or proposed system configuration meeting a functional requirement of the system and, furthermore, being converted into a concrete system configuration, which is information representing the configuration of the system not including the abstract portions;
a performance measurement unit that, in a case where the concrete system configuration is generated by the functional requirement learning means executing the concretization processing during the learning, constructs a measurement system which is a measurement environment, based on the concrete system configuration, executes performance measurement processing on performance set in advance using the measurement system, and stores performance data resulting from the performance measurement processing in a storage device; and
a nonfunctional requirement learning unit learns with regard to a second learning model that outputs an evaluation value representing a potentiality of the concrete system configuration being able to exhibit performance meeting a nonfunctional requirement, using the performance data corresponding to the concrete system configuration measured by the performance measurement unit.

Also, in order to achieve the example object described above, a system design learning method that is performed by a computer according to an example aspect of the present disclosure includes:
a functional requirement learning step of, by executing concretization processing for converting abstract portions into concrete portions on a system requirement or proposed system configuration targeted for concretization, which is information representing a configuration of a system including the abstract portions, performing learning with regard to a first learning model that outputs an evaluation value representing a potentiality of the system requirement or proposed system configuration meeting a functional requirement of the system and, furthermore, being converted into a concrete system configuration, which is information representing the configuration of the system not including the abstract portions;
a performance measurement step of, in a case where the concrete system configuration is generated by the concretization processing being executed during the learning in the functional requirement learning step, constructing a measurement system which is a measurement environment, based on the concrete system configuration, executing performance measurement processing on performance set in advance using the measurement system, and storing performance data resulting from the performance measurement processing in a storage device; and
a nonfunctional requirement learning step of performing learning with regard to a second learning model that outputs an evaluation value representing a potentiality of the concrete system configuration being able to exhibit performance meeting a nonfunctional requirement, using the performance data corresponding to the concrete system configuration measured in the performance measurement step.

Furthermore, in order to achieve the example object described above, a computer-readable recording medium according to an example aspect of the present disclosure includes a program recorded on the computer-readable recording medium, the program including instructions that cause the computer to carry out:
a functional requirement learning step of, by executing concretization processing for converting abstract portions into concrete portions on a system requirement or proposed system configuration targeted for concretization, which is information representing a configuration of a system including the abstract portions, performing learning with regard to a first learning model that outputs an evaluation value representing a potentiality of the system requirement or proposed system configuration meeting a functional requirement of the system and, furthermore, being converted into a concrete system configuration, which is information representing the configuration of the system not including the abstract portions;
a performance measurement step of, in a case where the concrete system configuration is generated by the concretization processing being executed during the learning in the functional requirement learning step, constructing a measurement system which is a measurement environment, based on the concrete system configuration, executing performance measurement processing on performance set in advance using the measurement system, and storing performance data resulting from the performance measurement processing in a storage device; and
a nonfunctional requirement learning step of performing learning with regard to a second learning model that outputs an evaluation value representing a potentiality of the concrete system configuration being able to exhibit performance meeting a nonfunctional requirement, using the performance data corresponding to the concrete system configuration measured in the performance measurement step.

### Advantageous Effects of the Invention

According to the present disclosure, functional requirements and nonfunctional requirements can be comprehensively learned.

### BRIEF DESCRIPTION OF THE DRAWINGS

FIG. 1 is a diagram for describing automated design of a facial recognition system.

FIG. 2 is a diagram for describing the data structure of component information.

FIG. 3 is a diagram for describing the data structure of a system requirement.

FIG. 4 is a diagram for describing concretization rules.

FIG. 5 is a diagram for describing the data structure of a concretization rule.

FIG. 6 is a diagram showing an example of the system design learning apparatus.

FIG. 7 is a diagram showing an example of a system having a system design learning apparatus.

FIG. 8 is a diagram for describing an example of the operations of the system design learning apparatus.

FIG. 9 is a diagram for describing an example of the operations of the functional requirement learning unit.

FIG. 10 is a diagram for describing an example of the operations of functional requirement learning.

FIG. 11 is a diagram for describing an example of the operations for generating a configuration path and a component path.

FIG. 12 is a diagram for describing an example of the data structure of the search tree information.

FIG. 13 is a diagram for describing an example of a search tree.

FIG. 14 is a diagram for describing an example of the data structure of the configuration path.

FIG. 15 is a diagram for describing an example of the data structure of the component path.

FIG. 16 is a diagram for describing an example of the operations for updating the reward information.

FIG. 17 is a diagram for describing an example of the operations for confirming a reward and generating training data.

FIG. 18 is a diagram for describing an example of the data structure of the first training data.

FIG. 19 is a diagram for describing an example of the data structure of the training data.

FIG. 20 is a diagram for describing an example of the operations for performance measurement.

FIG. 21 is a diagram for describing an example of the operations of the learning unit.

FIG. 22 is a diagram for describing an example of the operations for learning the nonfunctional requirements.

FIG. 23 is a diagram for describing an example of the operations for generating a configuration path and a component path.

FIG. 24 is a diagram for describing an example of the operations for generating training data.

FIG. 25 is a diagram for describing an example of the data structure of the second training data.

FIG. 26 is a diagram for describing an example of the data structure of the second training data.

FIG. 27 is a diagram for describing an example of a computer that realizes the system design learning apparatus.

### EXAMPLE EMBODIMENTS

First, an overview will be given in order to facilitate understanding of the example embodiment described below.

### (System Design)

Designing a facial recognition system will be described as an example. When designing a facial recognition system, the designer first creates system requirements for the facial recognition system.

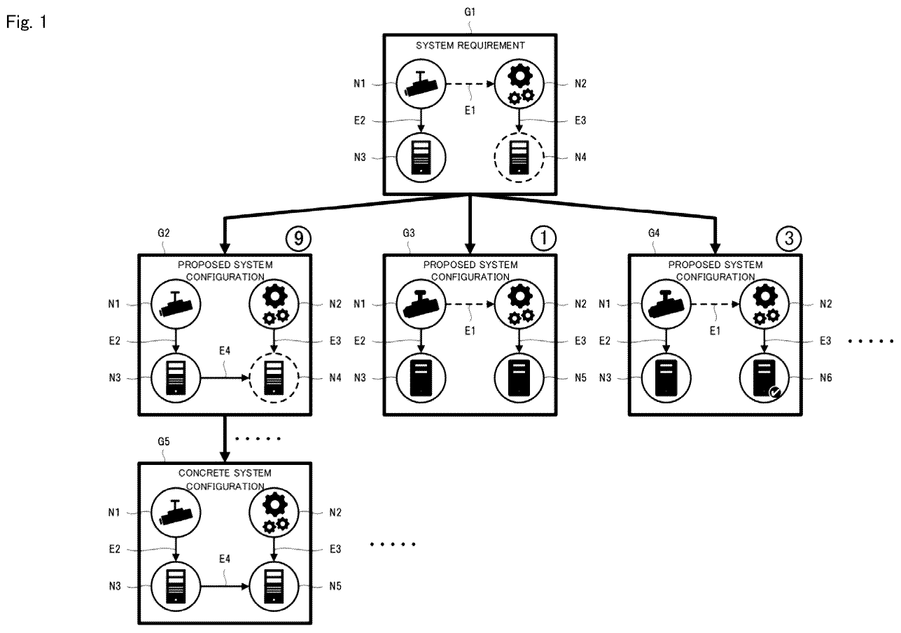

FIG. 1 is a diagram for describing automated design of a facial recognition system. Graph G1 in FIG. 1 is a graph representing the configuration of a system requirement R1 of the facial recognition system. Graph G1 in FIG. 1 is represented using nodes N1 to N4 and edges E1 to E3.

Node N1 represents a concrete camera function (solid circle), node N2 represents a concrete facial recognition function (solid circle), node N3 represents a concrete server computer function (solid circle), and N4 represents an abstract server computer function (dashed circle). Also, the edge E1 represents an abstract HTTP communication function (dashed arrow), and edges E2 and E3 represent concrete join (attribute) functions (solid arrows).

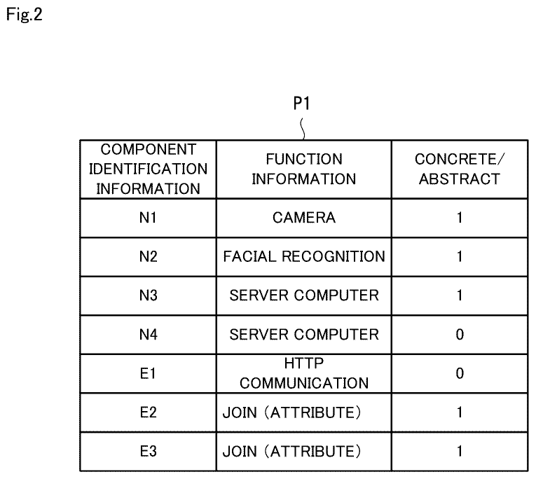

FIG. 2 is a diagram for describing the data structure of component information. In component information P1 shown in FIG. 2, for each component identification information identifying a node or an edge, function information indicating the function of the node or edge is associated with information indicating whether the node or edge is a concrete component configuration or an abstract component configuration (concrete (1)/abstract (0)).

In the example in FIG. 2, component identification information “N1”, function information “camera”, and information “1” indicating that the node is a concrete node are associated with each other. For each of component identification information “N2” to “N4” and “E1” to “E3”, function information and information indicating whether the node or edge is concrete or abstract are associated with each other in the same manner.

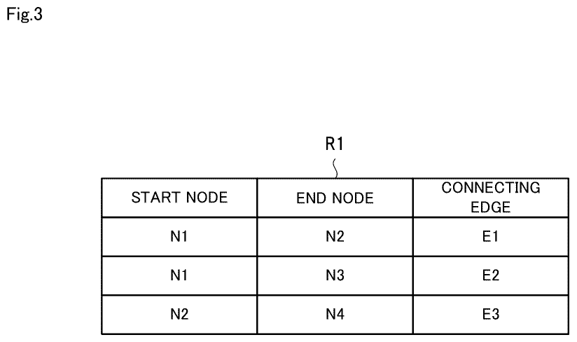

FIG. 3 is a diagram for describing the data structure of a system requirement. As shown in FIG. 3, the system requirement R1 corresponding to graph G1 shown in FIG. 1 is represented using two nodes (start node and end node) and an edge (connecting edge) connecting the two nodes.

Specifically, the system requirement R1 is information in which component identification information for identifying a node serving as the start point (start node), component identification information for identifying a node serving as the end point (end node), and component identification information for identifying the edge (connecting edge) connecting the two nodes are associated with each other.

Note that, in FIGS. 1 to 3 described above, an example of graphs, component information, and system requirements are described using graph G1, component information P1, and system requirement R1, but the graph, component information, and system requirement are not limited to graph G1, component information P1, and system requirement R1.

Next, in the automated design, abstract portions are converted into concrete portions. As shown in the example in FIG. 1, graphs G2, G3, G4 and so on corresponding to a plurality of proposed system configurations R2, R3, R4 and so on such as shown in FIG. 1 are derived from graph G1 corresponding to the system requirement R1, though concretization based on concretization rules.

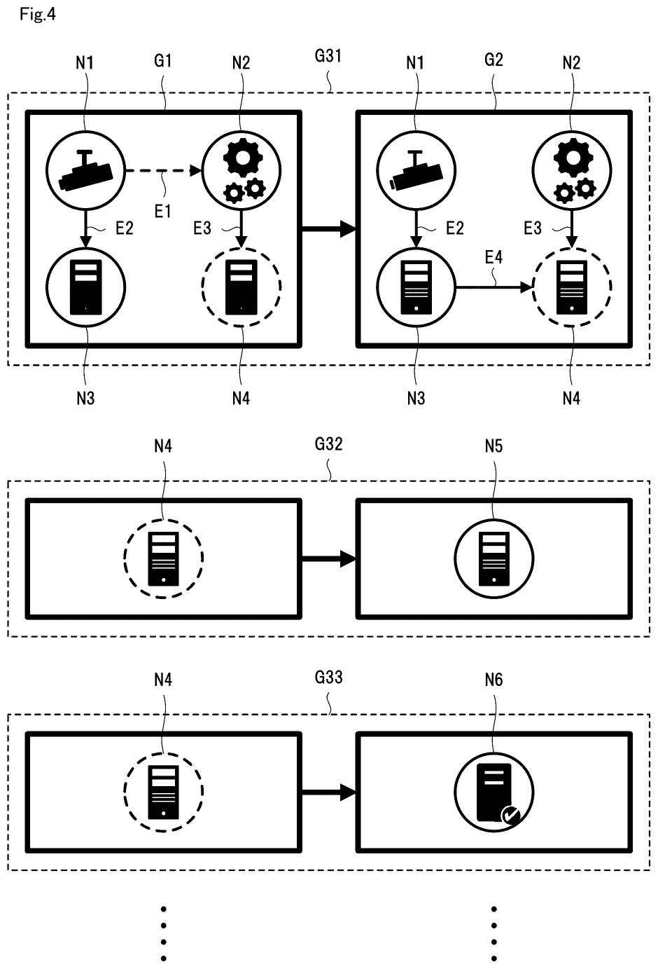

FIG. 4 is a diagram for describing concretization rules. FIG. 4 shows graphs G31, G32, G33 and so on that graphically represent a plurality of concretization rules.

Graph G31 is a graph representing a concretization rule Rule1 used in order to convert graph G1 shown in FIG. 1 into graph G2 shown in FIG. 1. Graph G32 is a graph representing a concretization rule Rule2 used in order to convert graph G1 shown in FIG. 1 into graph G3 shown in FIG. 1 (to convert node N4 into node N5). Graph G33 is a graph representing a concretization rule Rule3 used in order to convert graph G1 shown in FIG. 1 into graph G4 shown in FIG. 1 (to convert node N4 to node N6).

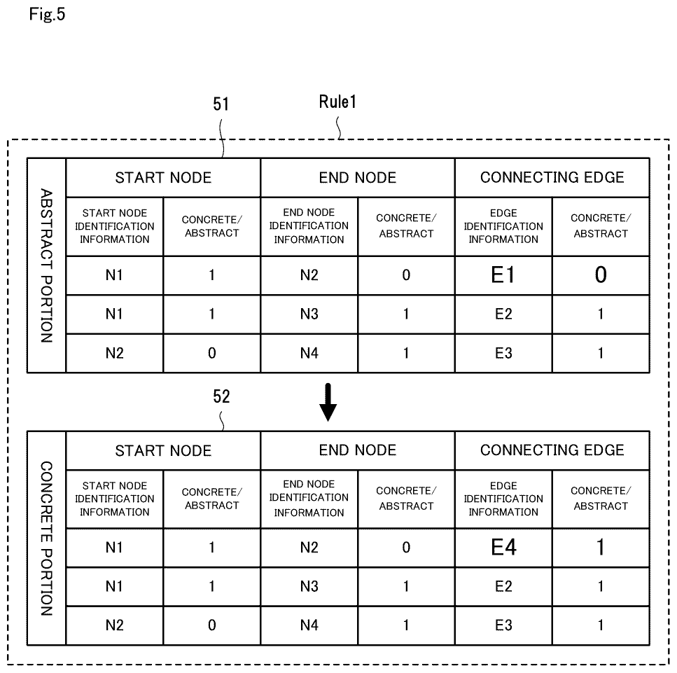

FIG. 5 is a diagram for describing the data structure of a concretization rule. The concretization rule Rule1 shown in FIG. 5 corresponds to graph G31. Also, the concretization rule Rule1 has detection information 51 that is used for detecting an abstract portion and conversion information 52 for converting the detection information 51 into a concrete portion.

Note that, although not illustrated, the concretization rules Rule2, Rule3, and so on corresponding to graphs G32, G33, and so on also exist for graphs G32, G33, and so on.

In the case of deriving graphs G2, G3, and G4 from graph G1 shown in FIG. 1, first, the system requirement R1 and a plurality of pieces of detection information (abstract portions of the concretization rules) are compared, and detection information matching the abstract portions included in the system requirement R1 is detected.

Next, the detected abstract portions of the system requirement R1 are changed to conversion information (concrete portions of concretization rules), using detection information corresponding to the detected abstract component configuration. In the conversion to graph G2, the system requirement R1 matches the detection information 51 of the concretization rule Rule1, and is thus replaced by (converted to) the conversion information 52 of the concretization rule Rule1.

As a result, the edge E1 is removed from the system requirement R1 and an edge E4 is added to generate the proposed system configuration R2 (not shown) corresponding to graph G2. Note that the proposed system configurations R3 and R4 (not shown) respectively corresponding to graphs G3 and G4 are also generated.

Next, for each of the generated plurality of proposed system configurations, abstract portions of the proposed system configuration are, furthermore, converted into concrete portions using concretization rules. Furthermore, when a proposed system configuration is generated, the above-described concretization processing is repeated. When proposed system configurations are no longer generated, and there are only concrete system configurations without abstract component configurations, the concretization processing is stopped (automated design is ended).

However, because a plurality of concretization rules are used when concretizing system requirements and proposed system configurations, the proposed system configurations and concrete system configurations that are derived change, depending on the concretization rules that are selected and the order in which the concretization rules are selected. That is, depending on the order in which the concretization rules are selected, different configurations of the proposed system configurations and concrete system configurations are derived.

Also, when a large number of concretization rules are applied, the numbers of proposed system configurations and concrete system configurations that are generated become huge. Furthermore, the plurality of different concrete system configurations may include concrete system configurations that do not meet the system requirements. Accordingly, concrete system configurations cannot be efficiently derived.

Also, in order to efficiently derive concrete system configurations, it is important to appropriately determine which concretization rules to apply and the advantages and disadvantages of the order in which the concretization rules are applied.

In view of this, evaluation values are derived using a learning model acquired by machine learning with respect to the proposed system configurations generated by executing concretization processing, and the proposed system configuration with the highest evaluation value is selected from among the proposed system configurations. In this way, a concrete system configuration can be efficiently derived, by repeating concretization processing that uses a learning model.

The learning model outputs an evaluation value (expected score, degree of promise) that represent the potentiality (possibility) of a target proposed system configuration being able to derive a concrete system configuration that meets the functional requirements.

In the example in FIG. 1, the learning model outputs “9” (encircled numerical value) as the expected score of the proposed system configuration R2 corresponding to graph G2, outputs “1” (encircled numerical value) as the expected score of the proposed system configuration R3 corresponding to graph G3, and outputs “3” (encircled numerical value) as the expected score of the proposed system configuration R4 corresponding to graph G3.

Next, in the example in FIG. 1, because the expected score “9” of the proposed system configuration R2 corresponding to graph G2 is the highest among the proposed system configurations R2 to R4, the proposed system configuration R2 corresponding to graph G2 is selected.

Next, concretization processing is executed on the proposed system configuration R2 corresponding to graph G2, a proposed system configuration is newly generated, an expected score of the proposed system configuration is newly output, and the proposed system configuration having the highest expected score is selected. In the example in FIG. 1, a concrete system configuration R5 corresponding to graph G5 is generated.

In this way, a concrete system configuration can be efficiently derived, by selecting the proposed system configuration with the highest expected score every time concretization processing is executed.

### (Training of Learning Model)

First, the above-described system requirements, proposed system configurations, and concrete system configurations represent system configurations related to functional requirements.

The learning model described above outputs expected scores for the proposed system configurations relating to functional requirements.

Next, Non-Patent Document 1 discloses utilizing reinforcement learning in training of the learning model described above. However, Non-Patent Document 1 does not clearly describe learning relating to nonfunctional requirements.

Accordingly, Non-Patent Document 1 also does not disclose or suggest comprehensive learning of functional requirements and nonfunctional requirements.

Furthermore, when it is attempted to simply learn functional requirements and nonfunctional requirements at the same time, the time taken for performance measurement of concrete system configurations, which is required in learning of nonfunctional requirements, bottlenecks and learning takes time.

Through such a process, the inventor discovered issues such as described above and also came to derive means for solving the related issues.

That is, the inventor came to derive means for comprehensively learning functional requirements and nonfunctional requirements. As a result, the learning time can be shortened, even if functional requirements and nonfunctional requirements are comprehensively learned.

### (Non-Functional Requirements)

A nonfunctional requirement is defined as a constraint equation of a system configuration (above-described system requirement, or proposed system configuration, or concrete system configuration) or a constraint equation of a component configuration included in a system configuration.

For example, assume that, in the facial recognition system of FIG. 1, the facial recognition function has a function of communicating with a camera function and capturing video data, and the speed of the above-described communication is required to be at least 10 [Mbps] (megabits per second: this similarly applies below).

In this case, the edge E1 of the system requirement R1 representing the configuration of the facial recognition system in FIG. 1 has a constraint equation indicating that the communication speed is 10 [Mbps] or more. The constraint equation can be represented by an inequality such as “communication speed ≥10 [Mbps]”, for example.

Also, in the case where the cost of the entire facial recognition system needs to be no more than 10 million yen, the facial recognition system has a constraint equation indicating that cost is 10 million yen or less. The constraint equation can be represented by an inequality such as cost≤10 million yen, for example.

### (Performance Measurement)

The reasons why performance measurement takes time include the following (1) and (2).

(1) Generating a concrete system configuration of an ICT system on which performance measurement is to be performed takes time. Even assuming that a concrete system configuration is constructed by automatic operation in a virtual environment, generating each element constituting the ICT system currently requires a few minutes or so, and thus generating an entire ICT system generally requires several tens of minutes to several hours.

(2) The performance measurement itself takes time. Simple performance measurement takes a few minutes or so for each performance measurement item, but when high-precision performance measurement is required, the system needs to be operated for a long time to acquire stable data. As a result, it is envisaged that performance measurement will take an unrealistic amount of time to perform at the same time as learning.

### (Learning Model for Non-Functional Requirements)

A learning model that has learned the nonfunctional requirements is used in order to determine how to proceed with concretization in the design. Specifically, when determining how to concretize a certain system requirement or proposed system configuration, the proposed system configurations or concrete system configurations that can be obtained by applying the concretization rules once to the system requirement or proposed system configuration are enumerated, and the evaluation values thereof relating to the nonfunctional requirements are calculated by the learning model.

It is then determined, based on the calculated evaluation values, which of the enumerated proposed system configurations or concrete system configurations to select. Note that the evaluation values are preferably expected values represented by scalar values or parameters for prescribing probability distributions. In the case where the probability distributions are mixed Gaussian distributions, for example, the parameters are preferably means, variances, mixing numbers or the like of the Gaussian distributions. The parameters are, however, not limited to the above-described means, variances, mixing numbers, and the like of the Gaussian distributions.

### EXAMPLE EMBODIMENT

Hereinafter, an example embodiment will be described with reference to the drawings. Note that, in the drawings described below, elements having the same functions or corresponding functions are denoted by the same reference numerals, and the redundant description thereof may also be omitted.

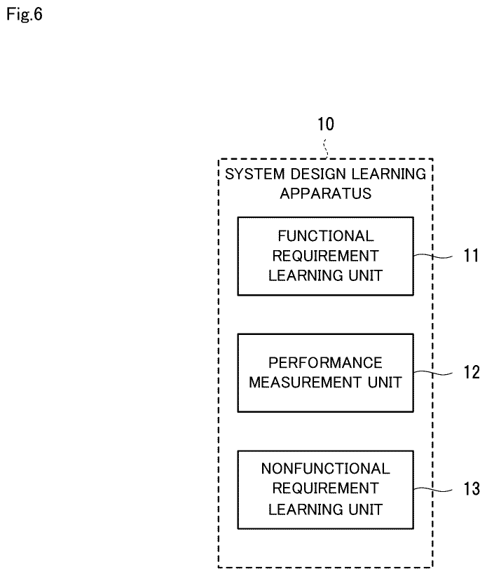

The configuration of a system design learning apparatus 10 of an example embodiment will be described, using FIG. 6. FIG. 6 is a diagram showing an example of the system design learning apparatus.

### [Apparatus Configuration]

The system design learning apparatus 10 shown in FIG. 6 is an apparatus for comprehensively learning functional requirements and nonfunctional requirements. The system design learning apparatus 10 has a functional requirement learning unit 11, a performance measurement unit 12, and a nonfunctional requirement learning unit 13.

The functional requirement learning unit 11, by executing concretization processing for converting abstract portions into concrete portions on a system requirement or proposed system configuration targeted for concretization, which is information representing the configuration of a system that includes abstract portions, performs learning with regard to a first learning model that outputs an evaluation value representing the potentiality of the system requirement or proposed system configuration meeting the functional requirements of the system and, furthermore, being converted into a concrete system configuration, which is information representing the configuration of a system that does not include abstract portions.

When a concrete system configuration is generated by the functional requirement learning unit 11 executing concretization processing at the time of learning, the performance measurement unit 12 constructs a measurement system which is a measurement environment based on the concrete system configuration, executes performance measurement processing on performance set in advance using the measurement environment, and stores performance data obtained from the performance measurement processing in a storage device.

The nonfunctional requirement learning unit 13 performs learning with regard to a second learning model that outputs an evaluation value representing the potentiality of the concrete system configuration being able to exhibit performance meeting the nonfunctional requirements, using the performance data corresponding to the concrete system configuration measured by the performance measurement unit 12.

In this way, in the example embodiment, functional requirement learning and nonfunctional requirement learning can be comprehensively executed, by providing the performance measurement unit 12 and executing nonfunctional requirement learning after executing functional requirement learning.

Also, the performance measurement time can be shortened, because functional requirement learning is performed first and the performance measurement processing is then executed on the measurement system constructed based on the concrete system configuration generated in the functional requirement learning to obtain performance data. As a result, the learning time can be shortened, even when functional requirements and nonfunctional requirements are comprehensively learned.

Furthermore, as the functional requirement learning progresses, the time taken to derive the concrete system configuration is shortened, and thus the time taken for functional requirement learning and nonfunctional requirement learning is shortened.

### [System Configuration]

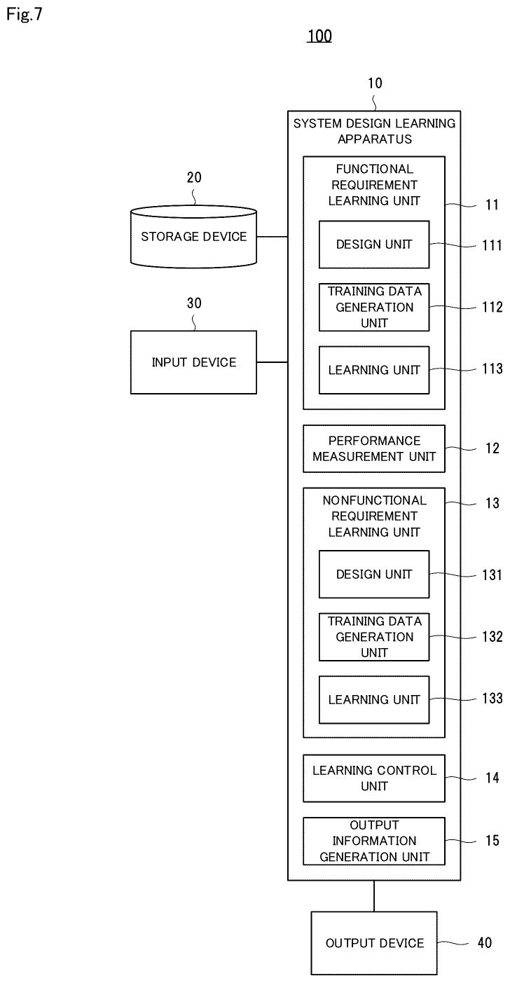

Next, the configuration of the system design learning apparatus 10 of the example embodiment will be described more specifically, using FIG. 7. FIG. 7 is a diagram showing an example of a system having a system design learning apparatus.

The system 100 has at least the system design learning apparatus 10, a storage device 20, an input device 30, and an output device 40. The system design learning apparatus 10, the storage device 20, the input device 30, and the output device 40 are connected in a communicable manner via a network.

The system design learning apparatus 10 is, for example, a CPU (Central Processing Unit), a programmable device such as an FPGA (Field-Programmable Gate Array), a GPU (Graphics Processing Unit), or an information processing apparatus such as a circuit, a server computer, a personal computer, or a mobile terminal equipped with one or more thereof.

The storage device 20 is a database, a server computer, a circuit having a memory, or the like. The storage device 20 stores at least information described later. In the example in FIG. 2, the storage device 20 is provided outside the system design learning apparatus 10 but may be provided inside the system design learning apparatus 10.

The input device 30 is, for example, a device such as a keyboard, a mouse, or a touch panel. The input device 30 is used when operating the system design learning apparatus 10, the output device 40, and the like.

The output device 40 acquires output information described later converted into an outputtable format by the output information generation unit 15, and outputs generated images, audio, and the like, based on the output information. The output device 40 is, for example, an image display device that uses liquid crystal, organic EL (Electro Luminescence), a CRT (Cathode Ray Tube), or the like. Furthermore, the image display device may be provided with an audio output device such as a speaker. Note that the output device 40 may be a printing device such as a printer.

The communication network is, for example, a general network constructed using communication lines such as the Internet, a LAN (Local Area Network), leased lines, telephone lines, a corporate network, a mobile communication network, Bluetooth (registered trademark), and WiFi (Wireless Fidelity).

### (System Design Learning Apparatus)

The system design learning apparatus will now be described in detail. The system design learning apparatus 10 of the example embodiment has the functional requirement learning unit 11, the performance measurement unit 12, the nonfunctional requirement learning unit 13, a learning control unit 14, and an output information generation unit 15.

The learning control unit 14 controls the functional requirement learning unit 11, the performance measurement unit 12, the nonfunctional requirement learning unit 13, and the like. The functional requirement learning unit 11 has a design unit 111, a training data generation unit 112, and a learning unit 113. The nonfunctional requirement learning unit 13 includes a design unit 131, a training data generation unit 132, and a learning unit 133.

The output information generation unit 15 generates output information for outputting, to the output device 40, system configurations, proposed system configurations, concrete system configurations, graphs, search tree information, information relating to the progress of learning (e.g., with regard to the first learning model for functional requirements, the number of search steps by the current first learning model, and, with regard to the second learning model for nonfunctional requirements, likelihoods for respective training data, mean values thereof, etc.), and the like, for example, and outputs the generated output information to the output device 40.

The design unit 111 converts abstract portions into concrete portions in a stepwise manner on the basis of the system requirements, which is information representing the configuration of a system including abstract portions, and generates proposed system configurations and concrete system configurations.

The training data generation unit 112 generates first training data for use in training of the first learning model.

The learning unit 113 executes training of the first learning model, using the first training data generated by the training data generation unit 112.

The design unit 131 converts abstract portions into concrete portions in a stepwise manner on the basis of the system requirements, which is information representing the configuration of a system including the abstract portions, and generates proposed system configurations and concrete system configurations.

The training data generation unit 132 generates second training data for use in training of the second learning model.

The learning unit 133 executes training of the second learning model, using the second training data generated by the training data generation unit 132.

### [Apparatus Operations]

Operations of the system design learning apparatus of the example embodiment will now be described. In the following description, the diagrams will be referred to as appropriate. Also, in the example embodiment, a system design learning method is implemented by operating the system design learning apparatus. Therefore, the following operation description of the system design learning apparatus will be given in place of description of the system design learning method of the example embodiment.
The operations of the system design learning apparatus will now be described.

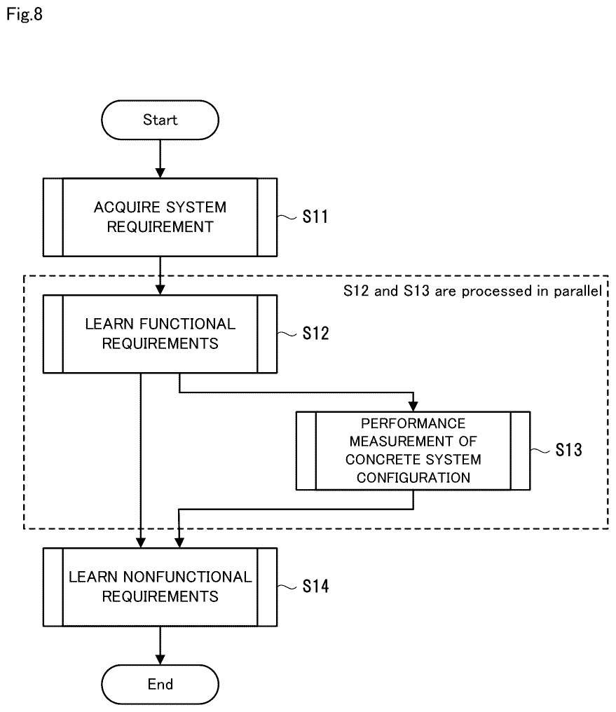

FIG. 8 is a diagram for describing an example of the operations of the system design learning apparatus. First, the learning control unit 14 acquires a system requirement to be learned from the storage device 20 (step S11).

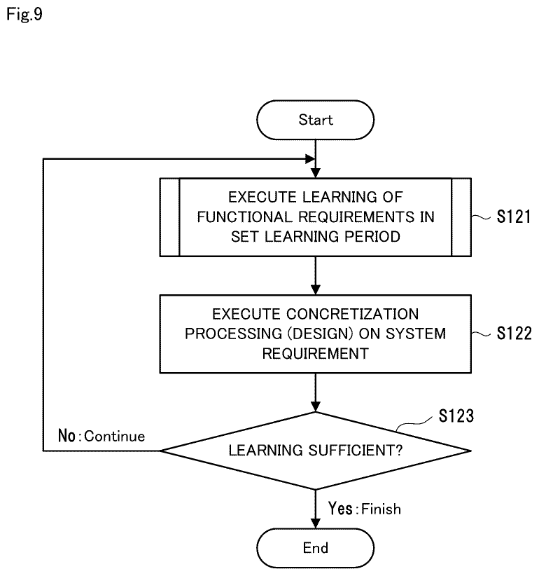

Next, the functional requirement learning unit 11 executes learning of functional requirements, using the acquired system requirement (step S12). Step S12 will be described in detail later with reference to FIG. 9.

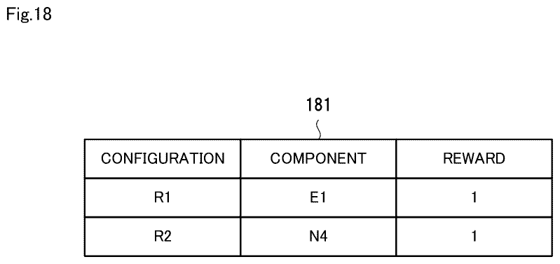

Also, the performance measurement unit 12 executes performance measurement processing on concrete system configurations that meet the functional requirements generated in step S12 to acquire performance data, and stores the acquired performance data in the storage device 20 (step S13). Step S13 will be described in detail later with reference to FIG. 18.

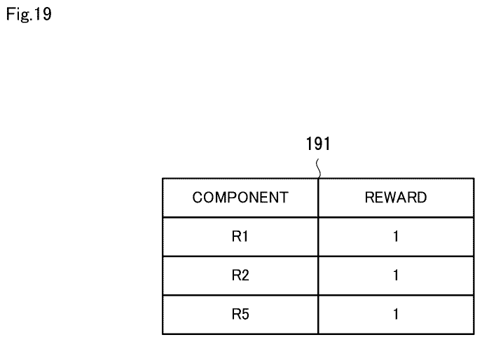

Next, the nonfunctional requirement learning unit 13 executes learning of nonfunctional requirements, using the system requirement and the performance data (step S14). Step S14 will be described in detail later with reference to FIG. 19.
The operations of the functional requirement learning unit 11 (step S12) will now be described.

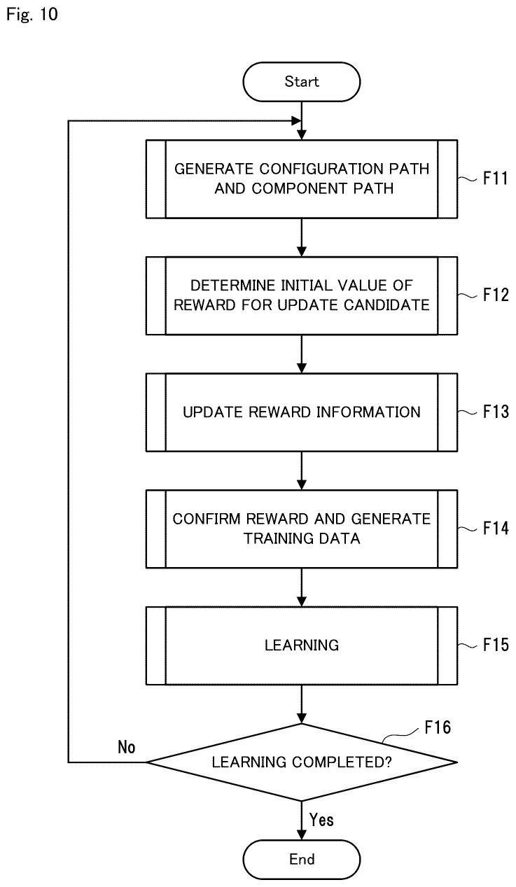

FIG. 9 is a diagram for describing an example of the operations of the functional requirement learning unit. First, the functional requirement learning unit 11 executes reinforcement learning of functional requirements in a learning period set in advance, using the system requirement (step S121). Note that step S121 will be described in detail later with reference to FIG. 10.

The learning period is determined by testing, simulation, or the like, for example. Also, the number of iterations of learning may be used instead of the learning period. In the case where a neural network is used in reinforcement learning, the number of updates of weights of the neural network is used as the number of iterations of learning.

Next, the functional requirement learning unit 11 executes concretization processing (design) on the system requirement, using the current first learning model (step S122).

The concretization processing is processing for concretizing abstract portions (component configurations) included in the system requirement. For example, when a neural network is used in reinforcement learning, the first learning model uses the neural network.

Next, if it is determined that learning of the functional requirements is sufficient, based on the result of step S122 (step S123: Yes), the functional requirement learning unit 11 ends the processing of step S12. If it is determined that learning of the functional requirements is not sufficient (step S123: No), the processing of steps S121 and S122 is repeated (continued), until it is determined that learning of the functional requirements is sufficient.

The determination in step S123 determines that learning is sufficient, when the number of search steps in the design is less than or equal to a threshold A set in advance, for example. Also, it may be determined that learning is sufficient when the number of search steps is less than or equal to a threshold B set in advance for a prescribed number of consecutive iterations in the design of step S122 implemented in the past. The determination in S123 is, however, not limited to the determination described above.

The number of search steps depends on the design of step S122. The number of search steps is the number of proposed configurations that were actually attained during the design. The number of search steps can also be paraphrased as the number of concretization rule actually applied during the design.

The thresholds A and B may be determined by any method with which it can be judged that the number of steps required in the design has been sufficiently reduced. For example, the least number of steps required for searching may be calculated beforehand, and a value (e.g., 10%) that provides the least number of steps with a margin to some extent may be taken as the thresholds A and B. Also, the number of search steps executed during a time period (e.g., 10 minutes) that is practically acceptable may be estimated beforehand, and the estimated value may be taken as the thresholds A and B.
The operations of functional requirement learning (step S121) will now be described.

FIG. 10 is a diagram for describing an example of the operations of functional requirement learning.

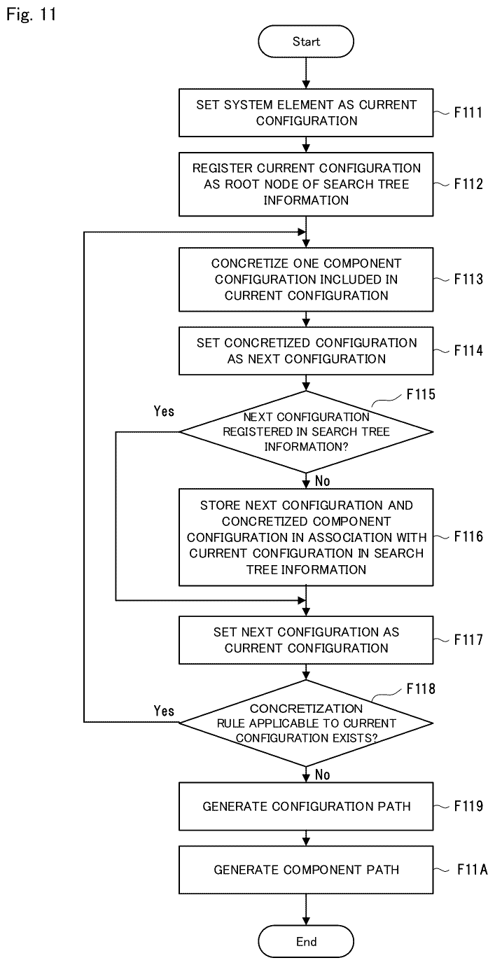

First, the design unit 111 generates a configuration path and a component path (step F11). Note that step F11 will be described in detail later with reference to FIG. 11.

Next, the training data generation unit 112 determines an initial value of a reward for an update candidate (step F12). Note that step F12 will be described in detail later.

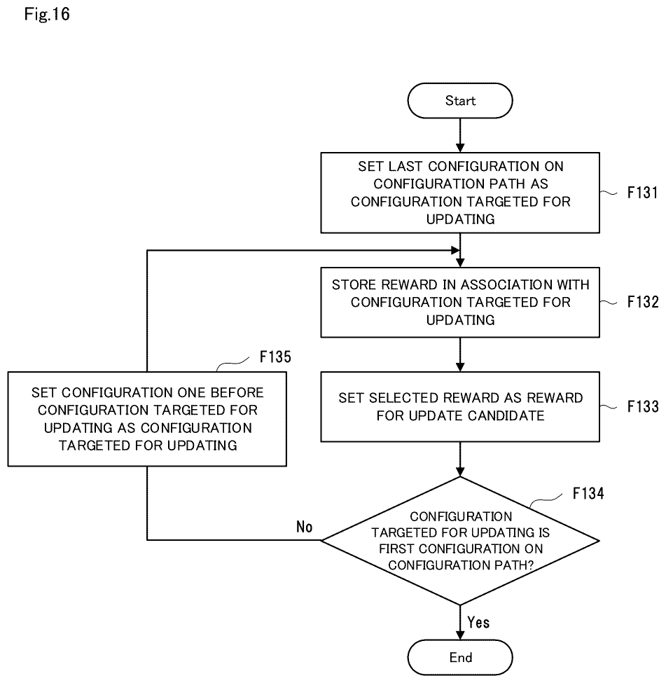

Next, the training data generation unit 112 updates the reward for each system configuration on the configuration path (step F13). Note that step F13 will be described in detail later with reference to FIG. 16.

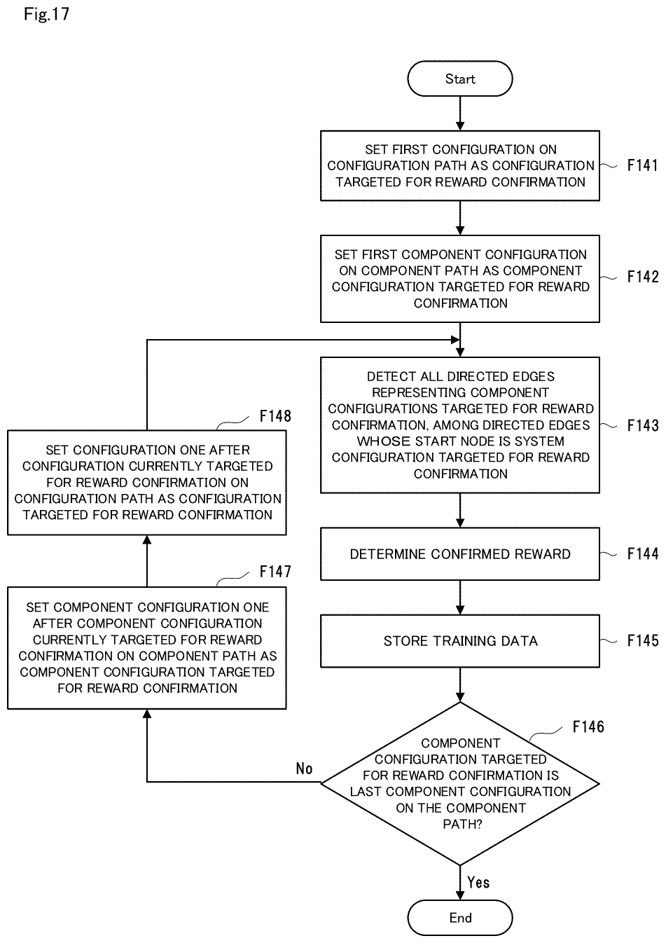

Next, the training data generation unit 112 confirms the reward for each system configuration on the configuration path and for each component configuration on the component path, and thereafter stores the training data in the storage device 20 (step F14). Note that step F14 will be described in detail later with reference to FIG. 17.

Next, the learning unit 113 executes learning (step F15). Note that step F15 will be described in detail later.

The processing of steps F11 to F15 is then repeated in the learning period set in advance (step F16). Note that step F16 will be described in detail later.
The operations for generating a configuration path and a component path (step F11) will now be described.

FIG. 11 is a diagram for describing an example of the operations for generating a configuration path and a component path.

First, the design unit 111 sets the system requirement as a current configuration (step F111). Next, the design unit 111 registers the current configuration as a root node of a search tree (step F112). Specifically, the design unit 111 stores system requirement identification information for identifying the current configuration (system requirement) in the search tree information as the root node.

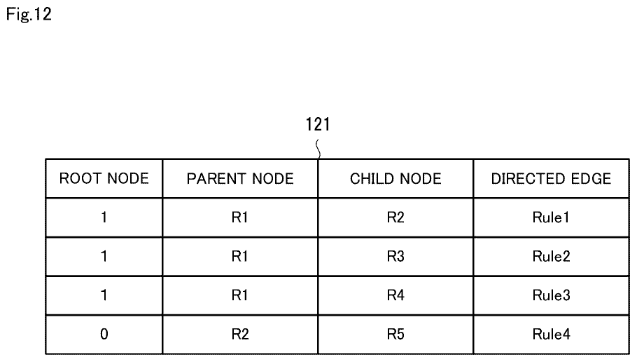

FIG. 12 is a diagram for describing an example of the data structure of the search tree information. In the example in FIG. 12, system requirement identification information “R1” associated with the system requirement R1 stored in the storage device 20 is stored in a “parent node” of a search tree information 121, and furthermore, information indicating that the system requirement R1 is the root node is stored in “root node”. Note that, in the example in FIG. 12, “1” is stored as information indicating that the system requirement R1 is the root node.

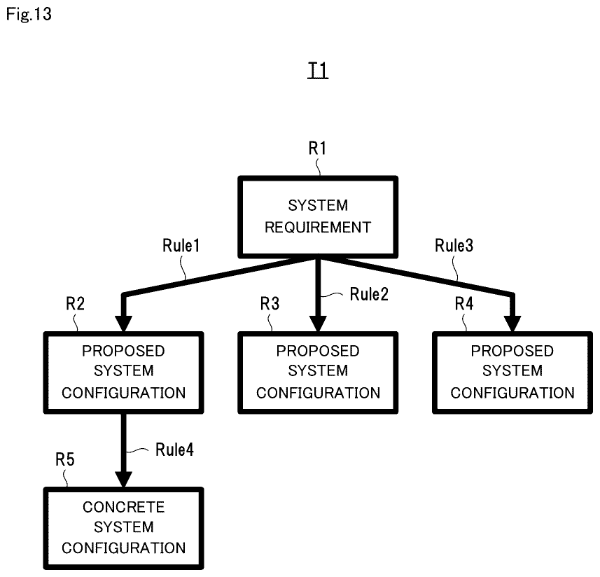

FIG. 13 is a diagram for describing an example of a search tree. A search tree can be represented by a graph (search tree T1) such as shown in FIG. 13. The root node (system requirement R1) shown in FIG. 12 corresponds to R1 in FIG. 13.

Next, the design unit 111 selects a concretization rule, using the current first learning model, executes the concretization processing, using the selected concretization rule, and concretizes a component configuration included in the current configuration (step F113). Next, the design unit 111 sets the configuration (proposed system configuration) concretized in step F113 as the next configuration (step F114).

Next, if the next configuration (concretized configuration (proposed system configuration)) is not stored in the search tree information (step F115: No), the design unit 111 transitions the processing to step F116. Also, if the next configuration (concretized configuration (proposed system configuration)) is stored in the search tree information (step F115: Yes), the design unit 111 transitions the processing to step F117.

Next, the design unit 111 sets the node representing the current configuration as a parent node, sets the next configuration (concretized configuration) as a child node, sets an edge representing the concretized component configuration (concrete component configuration of concretization rule) as a directed edge, and stores the current configuration, the next configuration, and the concretized component configuration in association with each other in the search tree information (step F116).

For example, when the proposed system configuration R2 is generated from the system requirement R1 which is the current configuration, the proposed system configuration identification information “R1” associated with the system requirement R1 of the search tree information 121, the proposed system configuration identification information “R2” associated with the proposed system configuration R2 generated by the concretization processing, and concretization rule identification information “Rule1” associated with the concretization rule used in the concretization processing are stored in association with each other, as shown in FIG. 12.

Also, when the concrete system configuration R5 is generated from the proposed system configuration R2 which is the current configuration, the proposed system configuration identification information “R2” of the search tree information 121, concrete system configuration identification information “R5” associated with the concrete system configuration generated by the concretization processing, and concretization rule identification information “Rule4” associated with the concretization rule used in the concretization processing are stored in association with each other, as shown in FIG. 12.

Next, the design unit 111 sets the next configuration as the current configuration (step F117). Next, if there are no concretization rules that can be applied to the current configuration (step F118: No), the design unit 111 transitions the processing to step F119. Note that concretization rules cannot be applied when the current configuration is a concrete system configuration. Also, if there is a concretization rule that can be applied to the current configuration (step F118: Yes), the design unit 111 repeats the processing of steps F113 to F117.

Next, the design unit 111 generates a path (configuration path information (configuration path) on which configurations that have been the current configuration are stored in chronological order) up until generation of the current concrete system configuration from the system requirement, using the system configurations (system requirement, proposed system configuration, concrete system configuration) that appeared in the processing from steps F111 to F118 described above (step F119).

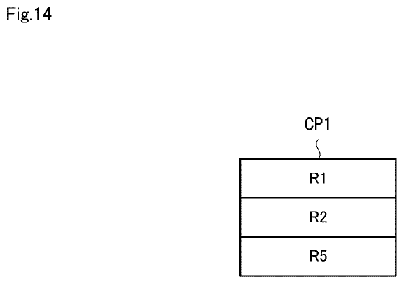

FIG. 14 is a diagram for describing an example of the data structure of the configuration path. In the example in FIG. 14, the configuration path CP1 is represented in order of system requirement “R1”, proposed system configuration “R2”, and concrete system configuration “R5”, as shown in FIGS. 12 and 13.

Next, the design unit 111 stores the abstract component configurations concretized in step F113 described above in chronological order and generates component path information (component path) (step F11A).

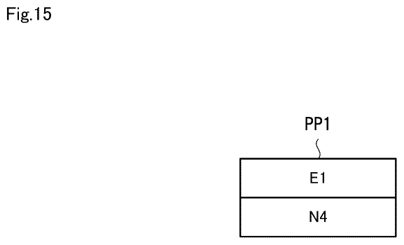

FIG. 15 is a diagram for describing an example of the data structure of the component path. When FIG. 13 (R1-R2-R5) is taken as corresponding to FIG. 1 (G1-G2-G5), the abstract component concretized in the conversion from R1 to R2 is the edge “E1”, and the abstract component concretized in the conversion from R2 to R5 is the node “N4”, and thus the component path is represented in the manner of PP1 shown in FIG. 15.

Note that, in the example embodiment, a method for learning an evaluation value (potentiality) for each component is described as an example, but an evaluation value (potentiality) for each component need not necessarily be learned, and, for example, an evaluation value of the entire system configuration may be learned. In that case, the edge registered in the processing of step F116 does not represent a specific component. Also, since the component path PP1 is not necessary, the processing of step F11A is not required.
The operations for determining the initial value of the reward for an update candidate (step F12) will now be described.

First, if the last configuration on the configuration path is a concrete system configuration, the training data generation unit 112 sets reward information indicating the reward for the concrete system configuration to “1”, for example, as the initial value of the reward for the update candidate, and, if the last configuration is not a concrete system configuration, sets the reward information indicating the reward corresponding to the concrete system configuration to “0”.

Note that the reward for the update candidate is a value used when updating the value of the reward obtained for each system configuration on the configuration path in step F13. This value is the value of a reward for finding that a system configuration can be obtained, as a result of the processing of the previous step F11.

Note that, in the example in FIG. 14, the last configuration on the configuration path CP1 is the concrete system configuration R5, and thus, in the processing of step F132, the reward information “1” is associated with “R5” indicating the concrete system configuration on the configuration path CP1.

Next, if the last configuration on the configuration path is a concrete system configuration, the training data generation unit 112 sets the concrete system configuration as a performance measurement target.

In the example in FIG. 14, the last configuration on the configuration path CP1 is the concrete system configuration R5, and thus system configuration identification information “R5” associated with the concrete system configuration R5 and indicating the concrete system configuration R5 is stored in the performance measurement target configuration list.
The operations for updating the reward information (step F13) will now be described.

FIG. 16 is a diagram for describing an example of the operations for updating the reward information. First, the training data generation unit 112 sets the last configuration on the configuration path as the configuration targeted for updating (step F131).

Next, the training data generation unit 112 compares the reward associated with the configuration targeted for updating and the reward for the update candidate, selects the larger reward, and stores the selected reward in association with the configuration targeted for updating (step F132).

Specifically, selecting the reward for the update candidate in step F132 means that, after comparing the reward associated with the configuration targeted for updating and the reward for the update candidate, the reward for the former is taken as “0” if this reward does not yet exist (has not yet been associated) prior to the comparison. After the comparison, the larger reward is then updated as the reward associated with the configuration targeted for updating and the reward for the update candidate. Thereafter, the configuration targeted for updating is updated and this processing is repeated.

For example, rewards are initially not associated with any of the configurations, and thus, in the example in FIG. 14, “R5” will be the first update candidate configuration in step F131, and because a reward is not yet associated therewith, the value thereof is taken as “0”. The reward for the update candidate is initialized to “1” in step F12, and thus “0” and “1” are compared, and because “1” is larger, the reward “1” is associated with “R5”. Next, the update candidate configuration is set to “R2” and similar processing to the processing described above is repeatedly executed.

Next, the training data generation unit 112 sets the reward selected in step F132 (larger reward upon comparison) as the reward for the update candidate (step F133). Next, for example, in the case where a reward “2” is associated with “R2”, the reward “2” associated with “R2” and the reward “1” for the update candidate are compared, and because “2” is larger, the reward “2” is associated with “R2” (no material change), and the reward for the update candidate is changed to “2”. Thereafter, the update candidate configuration will be “R1”, and the processing described above is repeated in a similar manner.

Next, if the configuration targeted for updating is not the first configuration on the configuration path (step F134: No), the training data generation unit 112 sets the configuration that is one before the configuration targeted for updating on the configuration path as the configuration targeted for updating (step F135), and transitions the processing to step F132.

Also, if the configuration targeted for updating is the first configuration on the configuration path and the first configuration (step F134: Yes), the training data generation unit 112 ends the processing of step F13.

Specifically, in the processing of step F13, data (rewards) for learning the evaluation values of the configurations “R2” and “R1” in the design process is generated on the basis of the evaluation value of the configuration “R5” at the end of the design, from the design performed in step F11. At this time, if larger data (reward) has been obtained in the past, the larger data is prioritized and is thus compared with the reward stored in association with the configuration and the larger of these two rewards is kept.

The reason why the larger reward is kept and propagated upward (“R1” as seen from “R2”) is because it is known that transition from “R1” to “R2” is possible. It is desired to learn the potential for rewards that will be obtained if the best choice continues to be selected, and since it is known that transition from “R1” to “R2” is possible if the appropriate concretization rule is applied, propagation to “R1” should be performed in preference to the reward of “R5” if the reward associated with “R2” is larger.

Note that transitioning from “R1” to “R2” is a possibility but will not necessarily occur. For example, in the example in FIG. 13, transitioning to “R3” or “R4” is also a possibility. Because the automated design function can, however, select which to transition to, the reward that is larger on comparison is propagated upward.
The operations for confirming a reward and generating training data (step F14) will now be described.

FIG. 17 is a diagram for describing an example of the operations for confirming a reward and generating training data. First, the training data generation unit 112 sets the first configuration on the configuration path as the configuration targeted for reward confirmation (step F141).

In the example in FIG. 14, “R1” indicating the system requirement R1 is stored as the first configuration on the configuration path CP1, and thus the system requirement R1 is set as the configuration targeted for reward confirmation.

Next, the training data generation unit 112 sets the first component configuration on the component path as the component configuration targeted for reward confirmation (step F142).

In the example in FIG. 15, “E1” indicating an abstract component is stored as the first component configuration on the component path PP1, and thus the component “E1” is set as the component configuration targeted for reward confirmation.

Next, the training data generation unit 112 detects all directed edges representing the component configuration targeted for reward confirmation, among the directed edges whose parent node (start node) is the system configuration targeted for reward confirmation (step F143).

In the example in FIG. 13, the configuration targeted for reward confirmation is the system requirement R1, and thus directed edges representing the component configuration targeted for reward confirmation are detected. Note that, in the example in FIG. 13, there is only one directed edge, but in examples other than the example in FIG. 13, a plurality of directed edges may also be detected.

The training data generation unit 112 sets the reward having the largest value, among the rewards relating to the functional requirements stored in association with the child nodes (end points) corresponding to the respective directed edges detected in step F143, as the confirmed reward (step F144).

The training data generation unit 112 stores the configuration targeted for reward confirmation, the component configuration targeted for reward confirmation, and the confirmed reward in association with each other in the storage device 20 as first training data (step F145).

FIG. 18 is a diagram for describing an example of the data structure of the first training data. Training data 181 in FIG. 18 represents the data structure of training data generated based on the CP1 and PP1 described above.

The confirmed reward is the evaluation value (potentiality) at the current point in time of the system configuration meeting the functional requirements, when the component configuration targeted for reward confirmation included in the configuration targeted for reward confirmation is concretized.

Here, it is desired to learn a quantitative index representing the potentiality of being able to eventually attain a concrete configuration after concretizing specific components of the configuration. Accordingly, the confirmed reward is part of the training data that is used to learn the index, and is also the actual provisional value of the index at the current point in time. It can also be said that the variables used in the process of generating the training data are appropriately named. Note that the confirmed rewards described above all represent those variables.

If the component configuration targeted for reward confirmation is not the last component configuration on the component path (step F146: No), the training data generation unit 112 sets the component configuration one after the component configuration currently targeted for reward confirmation on the component path as the component configuration targeted for reward confirmation (step F147), sets the configuration one after the configuration currently targeted for reward confirmation on the configuration path as the configuration targeted for reward confirmation (step F148), and thereafter transitions the processing to step F143.

If the component configuration targeted for reward confirmation is the last component configuration (step F146: Yes), the training data generation unit 112 ends the processing of step F14.

Also, if the component path is empty at the point in time at which the processing of step F14 is started, the processing of step F14 is skipped.

Note that the above-described processing relating to the component path need not be executed. In that case, the processing of step F142 will not be necessary. The processing of step F143 will also not be necessary. Also, in the processing of step F144, the reward relating to the functional requirement recorded in the node representing the configuration of the configuration targeted for reward confirmation is a confirmed reward. Also, in step F145, the configuration targeted for reward confirmation and the confirmed reward are stored in association with each other in the storage device 20 as first training data.

FIG. 19 is a diagram for describing an example of the data structure of the training data. Training data 191 in FIG. 19 represents the data structure of training data generated based on CP1 described above.

Also, since the processing of step F147 is not necessary, in step F146, it is determined whether the configuration targeted for reward confirmation is the last configuration on the configuration path, and, if not the last configuration, the processing advances to step F148, and, if the configuration targeted for reward confirmation is the last configuration on the configuration path, the processing of step F14 is ended.
The operations for learning (step F15) will now be described.

When the configuration targeted for reward confirmation included in the first training data is input to the first learning model, the learning unit 113 executes learning for correcting error in the output of the first learning model, such that the evaluation value output for the component configuration targeted for reward confirmation included in the first training data approaches the value of the confirmed reward included in the first training data.

Specific operations of step F15 will now be illustrated. The first learning model is given as a GNN (Graph Neural Network) that receives input of graph information representing attribute values of the nodes and edges within a graph and an attribute value of the graph itself, and outputs graph information of a similar format.

One piece of data D1 is selected from the training data, and a graph representing a reward confirmation target (configuration) included in the data D1 is input to the first learning model. Graph information output from the first learning model as a result is given as OG1.

In OG1, the attribute value of the node or edge corresponding to the component configuration (component) targeted for reward confirmation in data D1 is given as PV1. The pair of PV1 and the confirmed reward included in data D1 is given as VP1.

The result of generating VP1 for all the data included in the training data is given as VPS1. For each pair included in VPS1, the mean squared error between the attribute value and the confirmed reward is given as a loss function, and the first learning model is trained so as to minimize that loss function.

More specific operations of step F15 in the case where a component path is not generated will now be illustrated. The first learning model is given as a GNN that receives input of graph information representing attribute values of the nodes and edges within a graph, and outputs graph information of a similar format.

One piece of data D2 is selected from the training data, and graph information representing a reward confirmation target (configuration) included in the data D1 is input to the first learning model. Graph information output from the first learning model as a result is given as OG2.

In OG2, the attribute value of the graph itself is given as PV2. The pair of PV2 and the confirmed reward included in data D2 is given as VP2. The result of generating VP1 for all the data included in the training data is given as VPS2. For each pair included in VPS1, the mean squared error between the attribute value and the confirmed reward is given as a loss function, and the first learning model is trained so as to minimize that loss function.
The operations for performance measurement (step S13) will now be described.

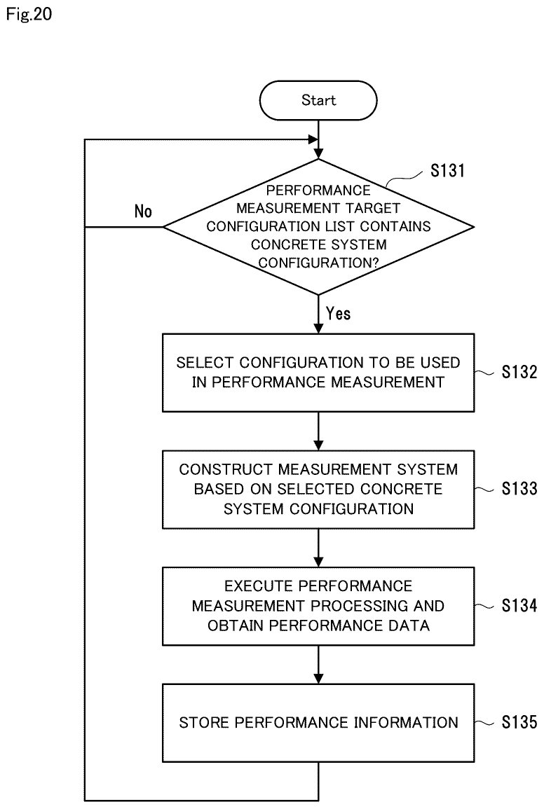

FIG. 20 is a diagram for describing an example of the operations for performance measurement. First, the performance measurement unit 12 determines whether there is a performance measurement target (step S131).

Specifically, if system configuration identification information that is associated with a concrete system configuration and indicates the concrete system configuration is stored in the performance measurement target configuration list (until the performance measurement target configuration list is empty), the performance measurement unit 12 executes the processing of steps S132 to S135.

If system configuration identification information is not stored in the performance measurement target configuration list (if the performance measurement target configuration list is empty), the performance measurement unit 12 waits until configuration identification information is stored in the performance measurement target configuration list.

Next, the performance measurement unit 12 selects a concrete system configuration to be used in performance measurement from the performance measurement target configuration list (step S132). The selection involves, for example, selecting configurations in the order in which the configurations were added to the performance measurement target configuration list. The selection is, however, not limited to the selection described above, and may be performed randomly.

Next, the performance measurement unit 12 constructs a measurement system, which is a measurement environment, based on the concrete system configuration selected in step S132 (step S133). Construction of the selected measurement system in step S133 utilizes a tool for automated measurement system construction, for example. As the tool, for example, Ansible (registered trademark), which is a configuration management tool, or a platform is used. As the platform, for example, AWS (Amazon Web Services) (registered trademark) is used.

Next, the performance measurement unit 12 executes performance measurement processing on the measurement system constructed in step S133 and acquires performance data of the measurement system (step S134). In the performance measurement, the type of performance to be measured may be set in advance or may be input separately.

Communication bandwidth will now be described as an example of performance measurement. To measure communication bandwidth, for example, iPerf (registered trademark), which is a tool that executes measurement and tuning of network performance, is utilized.

The communication bandwidth is measured, by first installing iPerf on information processing apparatuses PC1 and PC2 which are at both ends of the communication whose bandwidth is to be measured, and then starting one information processing apparatus PC1 in server mode, and starting the other information processing apparatus PC2 in client mode.

Also, measurement of communication delay utilizes software such as ping, for example. ping is a software that is implemented in advance in OS (operating systems) such as Windows (registered trademark) and Linux (registered trademark). The round-trip time of communication, that is, the communication delay, is measured by executing ping in which the information processing apparatus PC2 is set as the destination from the information processing apparatus PC1, out of the information processing apparatuses PC1 and PC2 at both ends of the communication whose delay is to be measured.

The performance measurement described above is, however, an example, and any method of performance measurement capable of quantitatively evaluating performance may be used. Also, the measured performance may be other than communication bandwidth or communication delay. In that case, an appropriate measurement method is employed according to the type of performance to be measured.

Next, the performance measurement unit 12 stores performance information in which system configuration identification information indicating the concrete system configuration and the performance data obtained by the performance measurement processing in step S134 are associated with each other in the storage device 20 (step S135). Next, when step S135 is completed, the performance measurement unit 12 transitions the processing to step S131.

Note that if the performance of the concrete system configuration selected in step S132 has already been measured, the processing from step S133 to step S135 may be skipped.

Also, the determination as to whether the performance of the concrete system configuration selected in step S132 has already been measured is made based on, for example, whether performance information of the same concrete system configuration is stored in the storage device 20.

Also, the processing of step S13 can be executed while executing the processing of step S12 (steps S12 and S13 can be processed in parallel).

Also, if step S13 is waiting at step S131 when the processing of step S12 ends, the processing of step S13 is not executed.
The operations of the nonfunctional requirement learning unit 13 (step S14) will now be described.

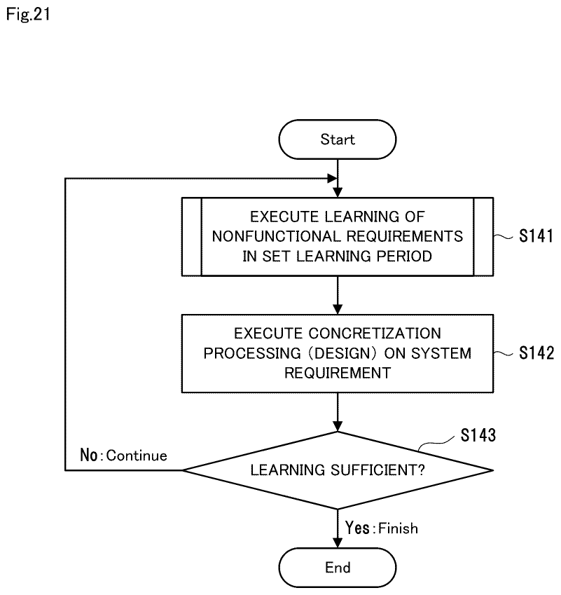

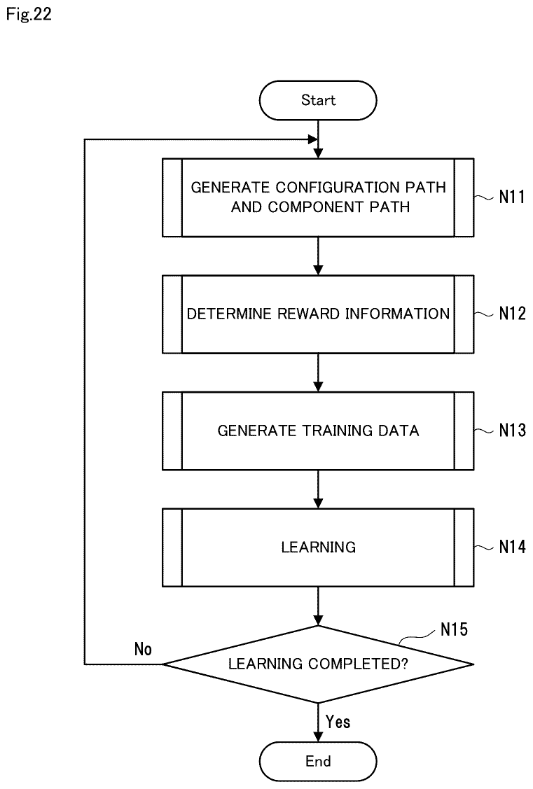

FIG. 21 is a diagram for describing an example of the operations of the learning unit. First, the nonfunctional requirement learning unit 13 executes reinforcement learning of the nonfunctional requirements in a learning period set in advance, using the system requirement and performance information (step S141). Note that step S141 will be described in detail later with reference to FIG. 22.

The learning period is conceivably a learning time period, the number of iterations of learning, or the like. The learning period is determined by testing, simulation, or the like, for example. Note that when a neural network is used in reinforcement learning, the number of updates of the weights of the neural network is used as the number of iterations of learning.

Next, the nonfunctional requirement learning unit 13 estimates the performance of one or more concrete system configurations generated, based on the system requirement, using the current second learning model (step S142).

Next, if it is determined that learning of the nonfunctional requirements is sufficient, based on the result of step S142 (performance estimation result) (step S143: Yes), the nonfunctional requirement learning unit 13 ends the processing of step S14. If it is determined that learning of the nonfunctional requirements is not sufficient (step S143: No), the processing of steps S141 and S142 is repeated until it is determined that learning of the nonfunctional requirements is sufficient.

The determination in S143 may be made based on, for example, whether the mean of the errors of the performance estimation result is less than or equal to a threshold C set in advance, or whether the likelihood or logarithmic likelihood of the performance estimation result is greater than or equal to a threshold D set in advance. The determination in S143 is, however, not limited to the determination described above.

The performance estimation result is an attribute value representing the performance value of a certain component of a certain concrete configuration that is included in a graph output as a result of inputting a graph representing the configuration to the second learning model, when estimating the performance of the component. The determination of step S143 is performed, using the error between the attribute value and the performance value obtained by actually measuring the performance of the component. Any method for determining the thresholds C and D by which it can be judged that the accuracy of performance estimation is sufficiently high may be employed. For example, the threshold C may be 10 [%], and the threshold D may be 0.001.
The operations for learning the nonfunctional requirements (step S141) will now be described.

FIG. 22 is a diagram for describing an example of the operations for learning the nonfunctional requirements.

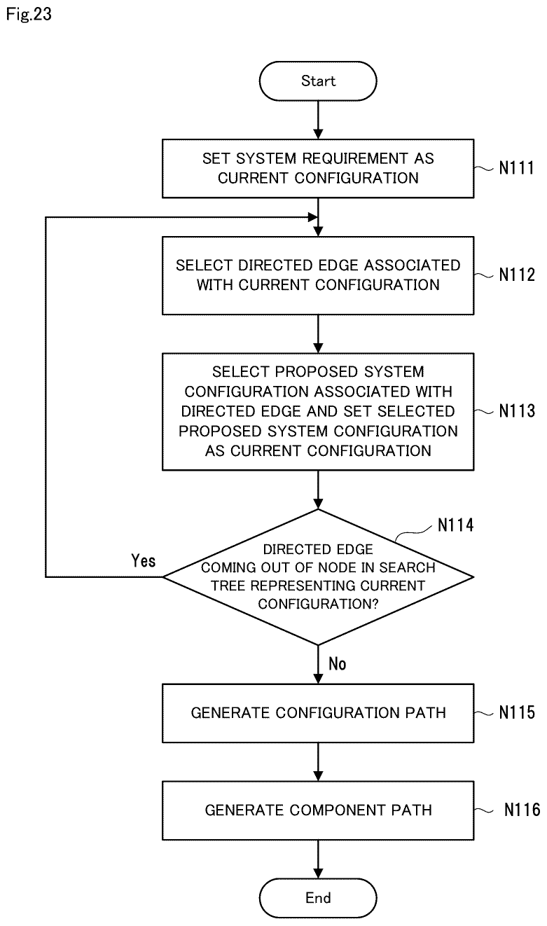

First, the design unit 131 generates a configuration path and a component path (step N11). Note that step N11 will be described in detail later with reference to FIG. 23.

Next, the training data generation unit 132 determines the values of rewards (step N12). Note that step N12 will be described in detail later.

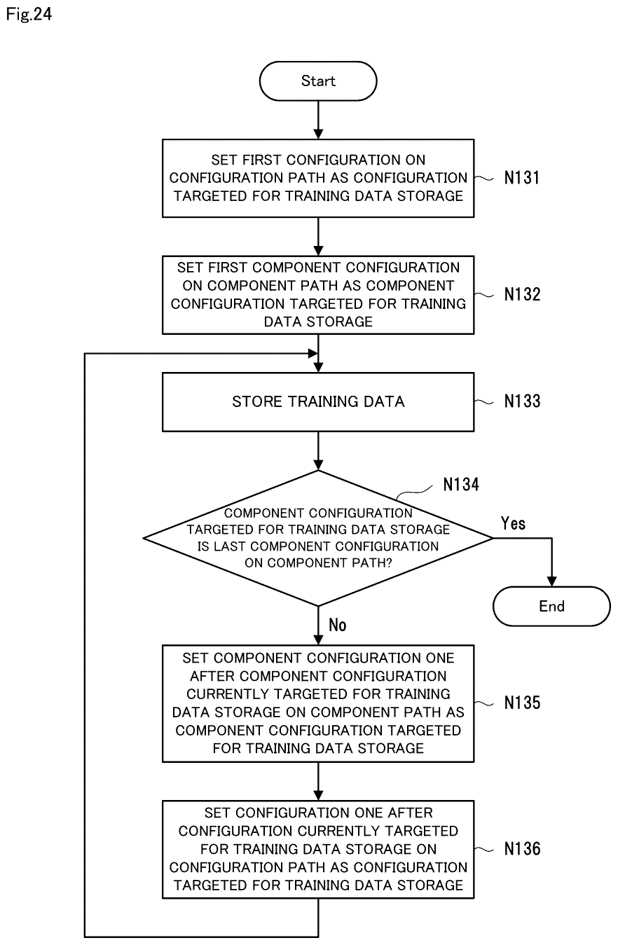

Next, the training data generation unit 132 confirms the reward for each system configuration on the configuration path and for each component configuration on the component path, and thereafter stores the training data in the storage device 20 (step N13). Note that step N13 will be described in detail later with reference to FIG. 24.

Next, the learning unit 133 executes learning (step N14). Note that step N14 will be described in detail later.

In the learning period set in advance, the processing of steps N11 to N14 is repeated (step N15).

An appropriate period is preferably one that is based on a learning time period or the number of iterations of learning (e.g., the number of updates of weights of the neural network, in the case of reinforcement learning that utilizes a neural network), but is not limited thereto.
The operations for generating a configuration path and a component path (step N11) will now be described.

FIG. 23 is a diagram for describing an example of the operations for generating a configuration path and a component path.

First, the design unit 131 sets the system requirement as the current configuration (step N111). Next, the design unit 131 selects one of the one or more concretization rules (directed edges) associated with the system requirement (parent node) which is the root node, with reference to the search tree information at the point in time at which the processing of step S12 ended (step N112).

In the example in FIG. 12, one directed edge is selected from the directed edges “Rule1”, “Rule2”, and “Rule3” indicating the proposed system configurations associated with “R1” indicating the system requirement R1, which is a parent node and the root node of the search tree information 121. In the example in FIG. 13, one directed edge is selected from the plurality of directed edges Rule1 to Rule3 associated with the root node R1 (parent node).

Next, the design unit 131 selects the proposed system configuration (child node) associated with the concretization rule (directed edge) selected in step N112, and sets the selected proposed system configuration as the current configuration (step N113).

Next, if there is a directed edge coming out of the node in the search tree representing the current configuration (step N114: Yes), the design unit 131 repeats the processing of steps N112 to N113. Also, if there is not a directed edge coming out of the node in the search tree representing the current configuration (step N114: No), the design unit 131 transitions the processing to step N115.

Next, the design unit 131 generates a path (configuration path information (configuration path) by storing the configurations that have been the current configuration in chronological order) up until generation of the current concrete system configuration from the system requirement, using the configurations (system requirement, proposed system configuration, concrete system configuration) that appeared in the processing from steps N111 to N114 described above (step N115).

Next, the design unit 131 generates component path information (component path) by storing the component configurations concretized in step N112 described above in chronological order (step N116).

Note that, in the example embodiment, a method for learning an evaluation value (potentiality) for each component is described as an example, but it is not necessarily required to learn an evaluation value (potentiality) for each component, and, for example, an evaluation value for the entire system configuration may be learned. In that case, the edges registered in the processing of step N112 do not represent specific components. Also, since the component path is not necessary, the processing of step N116 is not required.

Furthermore, because the processing of the design unit 111 and the processing of the design unit 131 have similar functions, the processing of the design unit 131 may be executed by the design unit 111. Doing so enables the design unit 131 to be eliminated.
The operations for determining reward information (step N12) will now be described.

The training data generation unit 132 acquires performance data corresponding to the last configuration on the configuration path, with reference to the performance information, and determines a reward, based on the value of the acquired performance data.

Essentially, the value of the performance value itself is simply set as the value of the reward. For example, if the bandwidth is 100 [Mbps], the reward is set to 100. Which unit is to be used for each performance value is, however, appropriately decided in advance (e.g., based on the frequency of use). For example, if it is decided to use Mbps as the unit of the bandwidth, 1 [Gbps] (gigabits per second; this similarly applies below) is 1000 [Mbps], and thus the reward is set to 1000. Also, because it is advantageous for the scale of the values that are learned to be smaller, a value obtained through logarithmic conversion of the performance value may be set as the value of the reward.

Rewards may, for example, be provided for each type of nonfunctional requirement such as bandwidth and delay or may be combined as one unified reward.

When rewards are provided for each type of nonfunctional requirement, the values of the performance data may be directly used as rewards (reward determination method 1). Also, in relation to performance indicating that larger values are better, rewards relating to corresponding nonfunctional requirements may directly take the values of the performance data, and, in relation to performance indicating that smaller values are better, rewards relating to the corresponding nonfunctional requirements may take the reciprocal of the values of the performance (reward determination method 2).

Also, in the case of combining the rewards as one unified reward, it is preferable to set, as the reward, a value obtained by adding appropriate weights to the rewards for each type of nonfunctional requirement determined by the reward determination method 2.
The operations for generating training data (step N13) will now be described.

FIG. 24 is a diagram for describing an example of the operations for generating training data. First, the training data generation unit 132 sets the first configuration on the configuration path generated in the processing of step N11 as the configuration targeted for training data storage (targeted for storage as second training data) (step N131).

Next, the training data generation unit 132 sets the first component configuration on the component path as the component configuration targeted for training data storage (targeted for storage as second training data) (step N132).

Next, the training data generation unit 132 stores the configuration targeted for training data storage, the component configuration targeted for training data storage, and the rewards determined in step N13 in association with each other in the storage device 20 as second training data. (step N133).

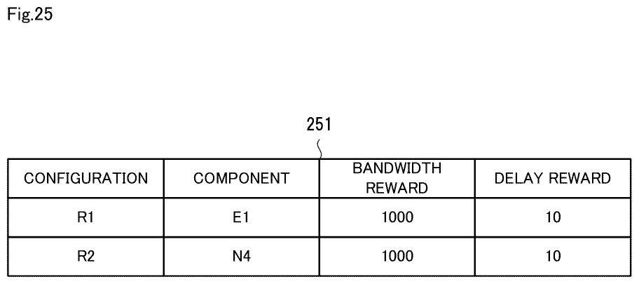

FIG. 25 is a diagram for describing an example of the data structure of the second training data. The example of training data 251 in FIG. 25 represents the data structure of training data generated based on the configuration path, component path, bandwidth reward, and delay reward.

The rewards are the evaluation values (potentialities) at the current point in time of performance exhibited by the concrete system configuration, when the above-described targeted component configuration included in the above-described targeted configuration is concretized.

Here, it is desired to learn a quantitative index representing the potentiality of how much performance can eventually be obtained after concretizing specific components of the configuration, or the probability density function thereof. The rewards are part of the training data that is used to learn the index and are also the obtained performance data itself. Also, it can be said that the variables used in the process of generating the training data are appropriately named. The rewards described above all represent those variables.

Next, if the component configuration targeted for training data storage in step N131 is not the last component configuration on the component path (step N134: No), the training data generation unit 132 sets the component configuration one after the component configuration currently targeted for training data storage on the component path as the component targeted for training data storage (step N135), sets the configuration one after the configuration currently targeted for training data storage on the configuration path as the configuration targeted for training data storage (step N136), and thereafter transitions the processing to step N133.

If the component configuration targeted for training data storage is the last component configuration (step N134: Yes), the training data generation unit 132 ends the processing of step N13.

Note that the above-described processing relating to the component path need not be executed. In that case, the processing of step N132 will not be necessary. Also, in the processing of step N133, the configuration targeted for training data storage and the rewards determined in the processing of step N13 are stored in association with each other in the storage device 20 as second training data.

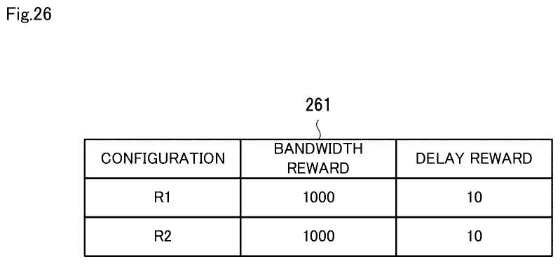

FIG. 26 is a diagram for describing an example of the data structure of the second training data. The example of training data 261 in FIG. 26 shows the data structure of training data generated based on the configuration path, bandwidth reward, and delay reward.

Also, in the processing of step N134, it is determined whether the configuration targeted for training data storage is the last configuration on the configuration path, and if not the last configuration, the processing transitions to step N136, and, if the last configuration, the processing of step N13 is ended and the processing transitions to step N14.
The operations for learning (step N14) will now be described in detail.

When the configuration targeted for training data storage included in the second training data is input to the second learning model, the learning unit 133 executes learning for correcting error in the output of the second learning model, such that the evaluation values output for the component configuration included in the second training data approaches the values of the rewards included in the second training data.

More specific operations of step N14 will now be illustrated. The second learning model is a GNN that receives input of graph information representing attribute values of the nodes and edges within a graph and an attribute value of the graph itself, and outputs a graph of a similar format.

One piece of data D3 is selected from the training data, and graph information representing the configuration included in the data D3 is input to the second learning model. Graph information output from the second learning model as a result is given as OG3. In OG3, the attribute value of the node or edge corresponding to the component configuration (component) of the data D3 is given as PV3.

The pair of PV3 and the rewards included in data D3 is given as VP3. The result of generating VP3 for all the data included in the training data is given as VPS3. For each pair included in VPS3, the mean squared error between the attribute value and the rewards is given as a loss function, and the second learning model is trained so as to minimize that loss function.

More specific operations of step N14 in the case where a component path is not generated will now be illustrated. The second learning model is a GNN that receives input of graph information representing attribute values of the nodes and edges within a graph and an attribute value of the graph itself, and outputs graph information of a similar format.

One piece of data D4 is selected from the training data, and graph information representing the configuration included in the data D4 is input to the second learning model. Graph information output from the second learning model as a result is given as OG4. In OG4, the attribute value of the graph itself is given as PV4. The pair of PV4 and the rewards included in data D4 is given as VP4.

The result of generating VP4 for all the data included in the training data is given as VPS4. For each pair included in VPS4, the mean squared error between the attribute value and the rewards is given as a loss function, and the second learning model is trained so as to minimize that loss function.

Also, as an example of processing different from the processing of step N14 described above, probability density functions of the rewards relating to the nonfunctional requirements may be learned. In that case, the following processing is performed using the second training data stored in step N13.

When the configuration included in the second training data is input to the second learning model, learning may be performed for correcting the parameters of a probability density function that is based on parameters of a probability density function that is output for a component configuration included in the second training data such that the likelihood of the probability density function for the values of rewards included in the training data increases.

Assuming that the probability density function of a reward follows a mixed Gaussian distribution, for example, the parameters of the probability density function are a mean value μ, a variance Σ, and a mixing coefficient π of each Gaussian distribution constituting the mixed Gaussian distribution. The example described above is one typical example, and the present disclosure is not limited to the example described above.

A method of correcting the parameters of the probability density function such that the likelihood of the probability density function increases preferably involves applying an EM algorithm, for example. The method is, however, not limited to an EM algorithm.

### Effects of Example Embodiment

According to the example embodiment as described above, learning relating to functional requirements and learning relating to nonfunctional requirements are separated, and learning of functional requirements is performed first, followed by learning of nonfunctional requirements.

By initially performing only learning of the functional requirements, learning of the functional requirements can be efficiently performed without waiting for performance measurement.

Performance measurement of concrete system configurations discovered during learning relating to the functional requirements is possible in parallel with the learning, and the time can be shortened.

As learning of the functional requirements progresses, the frequency with which concrete configurations are of discovered also increases, and thus measurement efficiency also increases. As a result, the time taken for learning can be reduced.

The technology disclosed in the present disclosure can be applied to reinforcement learning aimed at acquiring efficient procedures for intellectual tasks such as the design process of ICT systems.

### [Program]

The program according to the example embodiment may be a program that causes a computer to execute steps S11 to S14 shown in FIG. 8. By installing this program in a computer and executing the program, the system design learning apparatus and a system design learning method according to the example embodiment can be realized. In this case, the processor of the computer performs processing to function as the functional requirement learning unit 11, the performance measurement unit 12, the nonfunctional requirement learning unit 13, a learning control unit 14, and an output information generation unit 15.

Also, the program according to the embodiment may be executed by a computer system constructed by a plurality of computers. In this case, for example, each computer may function as any of the functional requirement learning unit 11, the performance measurement unit 12, the nonfunctional requirement learning unit 13, a learning control unit 14, and an output information generation unit 15.

### [Physical Configuration]

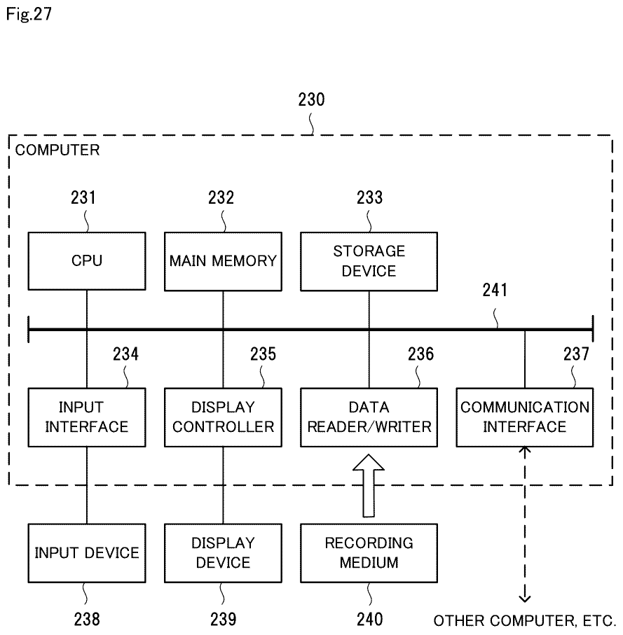

Here, a computer that realizes the system design learning apparatus by executing the program according to the example embodiment will be described with reference to FIG. 27. FIG. 27 is a diagram for describing an example of a computer that realizes the system design learning apparatus.

As shown in FIG. 27, a computer 230 includes a CPU (Central Processing Unit) 231, a main memory 232, a storage device 233, an input interface 234, a display controller 235, a data reader/writer 236, and a communications interface 237. These units are each connected so as to be capable of performing data communications with each other through a bus 241. Note that the computer 230 may include a GPU (Graphics Processing Unit) or an FPGA (Field-Programmable Gate Array) in addition to the CPU 231 or in place of the CPU 231.

The CPU 231 opens the program (code) according to this example embodiment, which has been stored in the storage device 233, in the main memory 232 and performs various operations by executing the program in a predetermined order. The main memory 232 is typically a volatile storage device such as a DRAM (Dynamic Random Access Memory). Also, the program according to this example embodiment is provided in a state being stored in a computer-readable recording medium 230. Note that the program according to this example embodiment may be distributed on the Internet, which is connected through the communications interface 237.

Also, other than a hard disk drive, a semiconductor storage device such as a flash memory can be given as a specific example of the storage device 233. The input interface 234 mediates data transmission between the CPU 231 and an input device 238, which may be a keyboard or mouse. The display controller 235 is connected to a display device 239, and controls display on the display device 239.

The data reader/writer 236 mediates data transmission between the CPU 231 and the recording medium 120, and executes reading of a program from the recording medium 120 and writing of processing results in the computer 230 to the recording medium 240. The communications interface 237 mediates data transmission between the CPU 231 and other computers.

Also, general-purpose semiconductor storage devices such as CF (Compact Flash (registered trademark)) and SD (Secure Digital), a magnetic recording medium such as a Flexible Disk, or an optical recording medium such as a CD-ROM (Compact Disk Read-Only Memory) can be given as specific examples of the recording medium 240.

Also, instead of a computer in which a program is installed, the system design learning apparatus according to this example embodiment can also be realized by using hardware corresponding to each unit. Furthermore, a portion of the system design learning apparatus may be realized by a program, and the remaining portion realized by hardware.

### [Supplementary Notes]

Furthermore, the following supplementary notes are disclosed regarding the example embodiments described above. Some portion or all of the example embodiments described above can be realized according to (supplementary note 1) to (supplementary note 15) described below, but the below description does not limit.

### (Supplementary Note 1)

A system design learning apparatus comprising:
a functional requirement learning unit that, by executing concretization processing for converting abstract portions into concrete portions on a system requirement or proposed system configuration targeted for concretization, which is information representing a configuration of a system including the abstract portions, learns with regard to a first learning model that outputs an evaluation value representing a potentiality of the system requirement or proposed system configuration meeting a functional requirement of the system and, furthermore, being converted into a concrete system configuration, which is information representing the configuration of the system not including the abstract portions;
a performance measurement unit that, in a case where the concrete system configuration is generated by the functional requirement learning means executing the concretization processing during the learning, constructs a measurement system which is a measurement environment, based on the concrete system configuration, executes performance measurement processing on performance set in advance using the measurement system, and stores performance data resulting from the performance measurement processing in a storage device; and
a nonfunctional requirement learning unit that learns with regard to a second learning model that outputs an evaluation value representing a potentiality of the concrete system configuration being able to exhibit performance meeting a nonfunctional requirement, using the performance data corresponding to the concrete system configuration measured by the performance measurement means.

### (Supplementary Note 2)

The system design learning apparatus according to claim 1,
wherein the functional requirement learning unit generates configuration path information, using the system requirement, the proposed system configuration, and the concrete system configuration, which are used while generating the concrete system configuration from the system requirement, and generates first training data by associating a reward with each of the system requirement, the proposed system configuration, and the concrete system configuration included in the configuration path information.

### (Supplementary Note 3)

The system design learning apparatus according to claim 1,
wherein the functional requirement learning unit generates component path information, using the abstract portions converted when the concretization processing is executed on the system requirement and the proposed system configuration, which are used while generating the concrete system configuration from the system requirement, and generates first training data by associating a reward for each performance data with each of the abstract portion corresponding to the system requirement and the abstract portion corresponding to the proposed system configuration included in the component path information.

### (Supplementary Note 4)

The system design learning apparatus according to claim 1,
wherein the nonfunctional requirement learning unit generates configuration path information, using the system requirement, the proposed system configuration, and the concrete system configuration, which are used while generating the concrete system configuration from the system requirement, and generates second training data by associating a reward with each of the system requirement, the proposed system configuration, and the concrete system configuration included in the configuration path information.

### (Supplementary Note 5)

The system design learning apparatus according to claim 1,
wherein the nonfunctional requirement learning unit generates component path information, using the abstract portions converted when the concretization processing is performed on the system requirement and the proposed system configuration, which are used while generating the concrete system configuration from the system requirement, and generates second training data by associating a reward for each performance data with each of the abstract portion corresponding to the system requirement and the abstract portion corresponding to the proposed system configuration included in the component path information.

### (Supplementary Note 6)

A system design learning method to be implemented by a computer executing:
a functional requirement learning step of, by executing concretization processing for converting abstract portions into concrete portions on a system requirement or proposed system configuration targeted for concretization, which is information representing a configuration of a system including the abstract portions, performing learning with regard to a first learning model that outputs an evaluation value representing a potentiality of the system requirement or proposed system configuration meeting a functional requirement of the system and, furthermore, being converted into a concrete system configuration, which is information representing the configuration of the system not including the abstract portions;
a performance measurement step of, in a case where the concrete system configuration is generated by the concretization processing being executed during the learning in the functional requirement learning step, constructing a measurement system which is a measurement environment, based on the concrete system configuration, executing performance measurement processing on performance set in advance using the measurement system, and storing performance data resulting from the performance measurement processing in a storage device; and
a nonfunctional requirement learning step of performing learning with regard to a second learning model that outputs an evaluation value representing a potentiality of the concrete system configuration being able to exhibit performance meeting a nonfunctional requirement, using the performance data corresponding to the concrete system configuration measured in the performance measurement step.

### (Supplementary Note 7)

The system design learning method according to claim 6,
wherein the functional requirement learning step of, generating configuration path information, using the system requirement, the proposed system configuration, and the concrete system configuration, which are used while generating the concrete system configuration from the system requirement, and generating first training data by associating a reward with each of the system requirement, the proposed system configuration, and the concrete system configuration included in the configuration path information.

### (Supplementary Note 8)

The system design learning method according to claim 6,
wherein the functional requirement learning step of, generating component path information, using the abstract portions converted when the concretization processing is executed on the system requirement and the proposed system configuration, which are used while generating the concrete system configuration from the system requirement, and generating first training data by associating a reward for each performance data with each of the abstract portion corresponding to the system requirement and the abstract portion corresponding to the proposed system configuration included in the component path information.

### (Supplementary Note 9)

The system design learning method according to claim 6,
wherein the nonfunctional requirement learning step of, generating configuration path information, using the system requirement, the proposed system configuration, and the concrete system configuration, which are used while generating the concrete system configuration from the system requirement, and generating second training data by associating a reward with each of the system requirement, the proposed system configuration, and the concrete system configuration included in the configuration path information.

### (Supplementary Note 10)

The system design learning method according to claim 6,
wherein the nonfunctional requirement learning step of, generating component path information, using the abstract portions converted when the concretization processing is performed on the system requirement and the proposed system configuration, which are used while generating the concrete system configuration from the system requirement, and generating second training data by associating a reward for each performance data with each of the abstract portion corresponding to the system requirement and the abstract portion corresponding to the proposed system configuration included in the component path information.

### (Supplementary Note 11)

A computer-readable recording medium including a program recorded thereon, the program including instructions that cause a computer to carry out:
a functional requirement learning step of, by executing concretization processing for converting abstract portions into concrete portions on a system requirement or proposed system configuration targeted for concretization, which is information representing a configuration of a system including the abstract portions, performing learning with regard to a first learning model that outputs an evaluation value representing a potentiality of the system requirement or proposed system configuration meeting a functional requirement of the system and, furthermore, being converted into a concrete system configuration, which is information representing the configuration of the system not including the abstract portions;
a performance measurement step of, in a case where the concrete system configuration is generated by the concretization processing being executed during the learning in the functional requirement learning step, constructing a measurement system which is a measurement environment, based on the concrete system configuration, executing performance measurement processing on performance set in advance using the measurement system, and storing performance data resulting from the performance measurement processing in a storage device; and
a nonfunctional requirement learning step of performing learning with regard to a second learning model that outputs an evaluation value representing a potentiality of the concrete system configuration being able to exhibit performance meeting a nonfunctional requirement, using the performance data corresponding to the concrete system configuration measured in the performance measurement step.

### (Supplementary Note 12)

The computer readable recording medium according to claim 11, the program further including instructions that causes a computer to carry out the steps of:
wherein the functional requirement learning step of, generating configuration path information, using the system requirement, the proposed system configuration, and the concrete system configuration, which are used while generating the concrete system configuration from the system requirement, and generating first training data by associating a reward with each of the system requirement, the proposed system configuration, and the concrete system configuration included in the configuration path information.

### (Supplementary Note 13)

The computer readable recording medium according to claim 11, the program further including instructions that causes a computer to carry out the steps of:
wherein the functional requirement learning step of, generating component path information, using the abstract portions converted when the concretization processing is executed on the system requirement and the proposed system configuration, which are used while generating the concrete system configuration from the system requirement, and generating first training data by associating a reward for each performance data with each of the abstract portion corresponding to the system requirement and the abstract portion corresponding to the proposed system configuration included in the component path information.

### (Supplementary Note 14)

The computer readable recording medium according to claim 11, the program further including instructions that causes a computer to carry out the steps of:
wherein the nonfunctional requirement learning step of, generating configuration path information, using the system requirement, the proposed system configuration, and the concrete system configuration, which are used while generating the concrete system configuration from the system requirement, and generating second training data by associating a reward with each of the system requirement, the proposed system configuration, and the concrete system configuration included in the configuration path information.

### (Supplementary Note 15)

The computer readable recording medium according to claim 11, the program further including instructions that causes a computer to carry out the steps of:
wherein the nonfunctional requirement learning step of, generating component path information, using the abstract portions converted when the concretization processing is performed on the system requirement and the proposed system configuration, which are used while generating the concrete system configuration from the system requirement, and generating second training data by associating a reward for each performance data with each of the abstract portion corresponding to the system requirement and the abstract portion corresponding to the proposed system configuration included in the component path information.

Although the present invention of this application has been described with reference to exemplary embodiments, the present invention of this application is not limited to the above exemplary embodiments. Within the scope of the present invention of this application, various changes that can be understood by those skilled in the art can be made to the configuration and details of the present invention of this application.

According to the above-described description, functional requirements and nonfunctional requirements can be comprehensively learned. Also, the technology disclosed in the present disclosure is useful in fields where automated design of ICT systems is required.

### LIST OF REFERENCE SIGNS

10 System design learning apparatus
11 Functional requirement learning unit
12 Performance measurement unit
13 Nonfunctional requirement learning unit
14 Learning control unit
15 Output information generation unit
20 Storage device
30 Input device
40 Output device
111 Design unit
112 Training data generation unit
113 Learning unit
111, 131 Design unit
112, 132 Training data generation unit
113, 133 Learning unit
230 Computer
231 CPU
232 Main memory
233 Storage device
234 Input interface
235 Display controller
236 Data reader/writer
237 Communications interface
238 Input device
239 Display device
240 Recording medium
241 Bus

What is claimed is:

1. A system design learning apparatus comprising:
at least one memory storing instructions; and
at least one processor configured to execute the instructions to:
by executing concretization processing for converting abstract portions into concrete portions on a system requirement or proposed system configuration targeted for concretization, which is information representing a configuration of a system including the abstract portions, learn with regard to a first learning model that outputs an evaluation value representing a potentiality of the system requirement or proposed system configuration meeting a functional requirement of the system and, furthermore, being converted into a concrete system configuration, which is information representing the configuration of the system not including the abstract portions;
in a case where the concrete system configuration is generated by executing the concretization processing during the learning, constructing a measurement system which is a measurement environment, based on the concrete system configuration, execute performance measurement processing on performance set in advance using the measurement system, and storing performance data resulting from the performance measurement processing in a storage device; and
learn with regard to a second learning model that outputs an evaluation value representing a potentiality of the concrete system configuration being able to exhibit performance meeting a nonfunctional requirement, using the performance data corresponding to the concrete system configuration measured by the performance measurement means.

2. The system design learning apparatus according to claim 1,
wherein the one or more processors further:
generates configuration path information, using the system requirement, the proposed system configuration, and the concrete system configuration, which are used while generating the concrete system configuration from the system requirement, and generates first training data by associating a reward with each of the system requirement, the proposed system configuration, and the concrete system configuration included in the configuration path information.

3. The system design learning apparatus according to claim 1,
wherein the one or more processors further:
generates component path information, using the abstract portions converted when the concretization processing is executed on the system requirement and the proposed system configuration, which are used while generating the concrete system configuration from the system requirement, and generates first training data by associating a reward for each performance data with each of the abstract portion corresponding to the system requirement and the abstract portion corresponding to the proposed system configuration included in the component path information.

4. The system design learning apparatus according to claim 1,
wherein the one or more processors further:
generates configuration path information, using the system requirement, the proposed system configuration, and the concrete system configuration, which are used while generating the concrete system configuration from the system requirement, and generates second training data by associating a reward with each of the system requirement, the proposed system configuration, and the concrete system configuration included in the configuration path information.

5. The system design learning apparatus according to claim 1,
wherein the one or more processors further:
generates component path information, using the abstract portions converted when the concretization processing is performed on the system requirement and the proposed system configuration, which are used while generating the concrete system configuration from the system requirement, and generates second training data by associating a reward for each performance data with each of the abstract portion corresponding to the system requirement and the abstract portion corresponding to the proposed system configuration included in the component path information.

6. A system design learning method to be implemented by a computer executing:
by executing concretization processing for converting abstract portions into concrete portions on a system requirement or proposed system configuration targeted for concretization, which is information representing a configuration of a system including the abstract portions, performing learning with regard to a first learning model that outputs an evaluation value representing a potentiality of the system requirement or proposed system configuration meeting a functional requirement of the system and, furthermore, being converted into a concrete system configuration, which is information representing the configuration of the system not including the abstract portions;
in a case where the concrete system configuration is generated by the concretization processing being executed during the learning in the functional requirement learning step, constructing a measurement system which is a measurement environment, based on the concrete system configuration, executing performance measurement processing on performance set in advance using the measurement system, and storing performance data resulting from the performance measurement processing in a storage device; and
performing learning with regard to a second learning model that outputs an evaluation value representing a potentiality of the concrete system configuration being able to exhibit performance meeting a nonfunctional requirement, using the performance data corresponding to the concrete system configuration measured in the performance measurement step.

7. A non-transitory computer-readable recording medium including a program recorded thereon, the program including instructions that cause a computer to carry out:
by executing concretization processing for converting abstract portions into concrete portions on a system requirement or proposed system configuration targeted for concretization, which is information representing a configuration of a system including the abstract portions, performing learning with regard to a first learning model that outputs an evaluation value representing a potentiality of the system requirement or proposed system configuration meeting a functional requirement of the system and, furthermore, being converted into a concrete system configuration, which is information representing the configuration of the system not including the abstract portions;
in a case where the concrete system configuration is generated by the concretization processing being executed during the learning in the functional requirement learning step, constructing a measurement system which is a measurement environment, based on the concrete system configuration, executing performance measurement processing on performance set in advance using the measurement system, and storing performance data resulting from the performance measurement processing in a storage device; and
performing learning with regard to a second learning model that outputs an evaluation value representing a potentiality of the concrete system configuration being able to exhibit performance meeting a nonfunctional requirement, using the performance data corresponding to the concrete system configuration measured in the performance measurement step.
